(19) United States
(12) Patent Application Publication
(10) Pub. No.: US 2018/0025373 A1
(43) Pub. Date: Jan. 25, 2018

(54) EVENT-TO-SPECTATOR CORRELATION TOOL

(71) Applicant: FanWide Technologies Inc., Seattle, WA (US)

(72) Inventors: Symon Warner Perriman, Seattle, WA (US); Harold Kenneth Hawkins, Pacific Grove, CA (US); Kevin Patrick Murphey, Seattle, WA (US)

(21) Appl. No.: 15/659,448

(22) Filed: Jul. 25, 2017

Related U.S. Application Data
(60) Provisional application No. 62/366,562, filed on Jul. 25, 2016.
(60) Provisional application No. 62/366,574, filed on Jul. 25, 2016.
(60) Provisional application No. 62/366,596, filed on Jul. 25, 2016.
(60) Provisional application No. 62/366,609, filed on Jul. 25, 2016.
(60) Provisional application No. 62/366,617, filed on Jul. 25, 2016.

(51) Int. Cl. G06Q 30/02; G06Q 50/00

(52) U.S. Cl. CPC G06Q 30/0205; G06Q 30/0201; G06Q 50/01; G06Q 30/0267

(57) ABSTRACT

An event-to-spectator correlation tool includes a multiprocessor computing system. The multiprocessor computing system has a first processor, a second processor, and at least one memory coupled to the multiprocessor computing system. The at least one memory is arranged to store computer instructions executable by the first and second processors of the multiprocessor computing system. The computer instructions are arranged to direct the multiprocessor computing system to identify a gathering to view an event at a venue. The computer instructions are further arranged to direct the multiprocessor computing system to determine a total possible attendance at the gathering, determine a regional popularity of the event, determine a global popularity of the event, and predict an expected attendance at the venue by cooperatively attenuating the total possible attendance based on a combination of the regional popularity of the event and the global popularity of the event.

### CROSS-REFERENCE TO RELATED APPLICATIONS

This application claims the priority benefit of U.S. Provisional Patent Application No. 62/366,562, filed Jul. 25, 2016, and entitled COMPUTATIONAL MODEL OF POPULARITY AND ATTENDANCE FOR VIEWING AN EVENT BASED ON REGIONAL FACTORS; this application claims the priority benefit of U.S. Provisional Patent Application No. 62/366,574, filed Jul. 25, 2016, and entitled COMPUTATIONAL MODEL OF POPULARITY AND ATTENDANCE FOR VIEWING AN EVENT BASED ON DATA REGARDING THE EVENT ITSELF; this application claims the priority benefit of U.S. Provisional Patent Application No. 62/366,596, filed Jul. 25, 2016, and entitled COMPUTATIONAL MODEL USED TO ESTIMATE THE POPULARITY AND ATTENDANCE FOR AN EVENT BASED ON DATA REGARDING EVENT PARTICIPANT AFFILIATIONS; this application claims the priority benefit of U.S. Provisional Patent Application No. 62/366,609, filed Jul. 25, 2016, and entitled COMPUTATIONAL MODEL USED TO ESTIMATE THE OPTIMAL NUMBER AND PLACEMENT OF EVENT HOSTS; this application claims the priority benefit of U.S. Provisional Patent Application No. 62/366,612, filed Jul. 25, 2016, and entitled AUCTION SYSTEM FOR EVENTS WITH BIDDER ELIGIBILITY BASED ON REGION AND PARTICIPANT DENSITY; and this application claims the priority benefit of U.S. Provisional Patent Application No. 62/366,617, filed Jul. 25, 2016, and entitled SOCIAL NETWORK THAT CONNECTS PARTICIPANTS WITH SIMILAR AFFILIATIONS AT SELECTED VIEWING LOCATIONS. Each of these applications is hereby incorporated by reference in its entirety.

### BACKGROUND

### Technical Field

The present disclosure generally relates to a tool that correlates spectators to a particular event. More particularly, but not exclusively, the present disclosure predicts how many spectators will attend a gathering to view the event based on regional and global adjustments to an available pool of parties interested in the particular event.

### Description of the Related Art

In many cases, providers of time-based services are engaged to deliver their services to an audience of an unknown size. For example, a band is hired to play music at a nightclub or restaurant, a popular celebrity is scheduled to speak at a certain auditorium, or a sporting contest is scheduled to occur at a certain forum. In these cases, an organizer will attempt to guess how many people will attend a gathering to view the event. The organizer uses this “guess” to plan a proper amount of food, drinks, security, and other such relevant goods, services, and sundries.

In many cases, the guess of likely attendance by the organizer is based on the organizer's experience, based on actual attendance at other comparable gatherings, and based on intuition or a “gut feeling.” If the gathering is an annual or otherwise recurring gathering, the organizer's guess may be very accurate. In other cases, the organizer's guess may be very inaccurate. For example, if the gathering does not have any available historical data from which to compare, the guess of attendance is likely to be less accurate. In addition, when certain factors or circumstances arise (e.g., inclement weather, competing gatherings, competing events, etc.), even if the organizer recognizes that the factor or circumstance will be influential, the guess of attendance at the particular gathering of interest is still likely to be inaccurate.

In cases where the organizer's guess of likely attendance is already very accurate, the accuracy may be improved even further using a known crowd prediction and attendance forecasting system. U.S. Pat. No. 8,768,867 B1 to Thaeler et al. describes such a system. Embodiments of Thaeler's system implement a method that begins with generating an initial attendance forecast for a venue such as a retail store, a restaurant, a bar, a nightclub, a museum, a theater, a stadium, an airport, a hotel, and a park. The initial attendance forecast is generated using a historical attendance prediction model and historical data. The historical data might be point-of-sale data, weather data, geo-position data, satellite image data, or traffic data. Thaeler's history-based modeling method can also be used to create a dynamic attendance prediction model for the venue based, at least in part, upon the initial attendance forecast and real-time data. The real-time data might be point-of-sale data, utility usage data, employee attendance data, audio or visual equipment usage data, number of detected internet-enabled devices data, reservation data, arrivals and departures data, and social network data. Finally, Thaeler's method can also include generating an updated attendance forecast for the venue using the dynamic attendance prediction model.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

In many cases, providers of time-based services are engaged to deliver their services to an audience of an unknown size. For example, a band is hired to play music at a nightclub or restaurant, a popular celebrity is scheduled to speak at a certain auditorium, or a sporting contest is scheduled to occur at a certain forum. In these cases, various stakeholders can benefit from knowing how many people are expected to attend the particular gathering.

Using predicted attendance information, one or more stakeholders can better and more accurately plan food, drinks, security operations, traffic patterns, environmental considerations (e.g., heating, air conditioning, ventilation), restroom facilities, electricity, wired or wireless network capacity, and the like.

Heretofore, the only known way to produce a reasonably accurate guess of expected attendance at a future gathering was in cases where the organizer of the gathering had previous experience, such as when the gathering was held annually or otherwise recurred on some other schedule. This historical approach toward predicting a size of an audience was improved in Thaeler, as previously described, but the conventional approach remains very limited.

Now, as discussed in the present disclosure, new systems and methods of correlating spectators at a gathering to a particular event are described in detail.

A method of executing a gathering to view an event at a venue may be summarized as including: predicting an expected attendance at the venue, by: determining a total possible attendance; determining a regional popularity of the event; determining a global popularity of the event; and cooperatively attenuating the total possible attendance based on a combination of the regional popularity of the event and the global popularity of the event; passing the predicted expected attendance to the venue; and conducting the event by: receiving participants at the venue; and counting the participants at the venue.

The venue may include a computing device associated with the venue and wherein the venue may be at least one of a restaurant, a bar, an auditorium, a stadium, a museum, a theater, an airport, a park, a hotel, a motel, a public meeting room, a domicile, and a park. The event may be at least one of a sporting event, a music concert, and a political event. Predicting the expected attendance may include: multiplying a first value, a second value, and a third value, wherein the first value represents the total possible attendance, wherein the second value represents the regional popularity of the event, and wherein the third value represents the global popularity of the event. The first value may be an integer and wherein the second value and the third value may be real numbers. Determining the total possible attendance may include: receiving, at a distributed computing server, location information associated with a determined number of interested parties, wherein each of the determined number of interested parties has assigned thereto an expressed interest in at least one of the event and the venue; and generating, with the distributed computing server, the first value as an accumulation of interested parties having at least some common location information. The location information may include at least one of a postal code, a portion of an internet protocol (IP) address, and global positioning system (GPS)-based information. The at least some common location information may include a plurality of postal codes, a plurality of IP address portions, and a geographic location within a determined geographic area. Determining the regional popularity of the event may include: establishing, at a distributed computing server, a regional popularity baseline value representing an average regional event with average regional popularity; setting, with the distributed computing server, a regional popularity working value to the regional popularity baseline value; and updating, with the distributed computing server, the regional popularity working value by increasing or decreasing the regional popularity working value based on individual values of a set of determined regional popularity factors, the set of determined regional popularity factors including one or more of: a conflicting event factor; a local economic indicator; a previous participation factor; a social demographic factor; a political factor; a local population density factor; a time-of-event factor; a third-party social media data factor; a weather forecast factor; a local availability of electronic delivery of the event factor; and a wildcard factor. Determining the global popularity of the event may include: establishing, at a distributed computing server, a global popularity baseline value representing an average global event with average global popularity; setting, with the distributed computing server, a global popularity working value to the global popularity baseline value; and updating, with the distributed computing server, the global popularity working value by increasing or decreasing the global popularity working value based on individual values of a set of determined global popularity factors, the set of determined global popularity factors including one or more of: a team win/loss record; a nature of the event factor; a factor representing status of individual participants; a current performance factor; an historical performance factor; a determined excitement factor; a competing-events factor; an estimated viewing attendance factor; a third-party social media data factor; and a wildcard factor.

A non-transitory computer-readable storage medium whose stored contents configure a computing system to perform a method may be summarized as including: electronically receiving information at a computing device, the information representing a primary event of interest, wherein the computing device is communicatively coupled to the computing system; identifying with the computing device a plurality of geographic regions having access to the primary event of interest; determining a total possible audience for a gathering directed toward the primary event of interest in each of the plurality of geographic regions; generating at least one regional event weighting factor for each region of the plurality of geographic regions, each regional event weighting factor associated with at least one geographic region having access to the primary event of interest; generating a global event weighting factor, the global event weighting factor associated with the primary event of interest; and predicting a plurality of expected attendance estimates, each of the plurality of expected attendance estimates being an expected attendance estimate for the gathering at a venue located within a respective geographic region, wherein each predicted expected attendance estimate is generated by mathematically combining an associated regional event weighting factor and the global event weighting factor with the associated total possible audience.

The method may further include: based on at least one of the plurality of expected attendance estimates, electronically communicating the at least one of the plurality of expected attendance estimates to the venue located within the respective geographic region. Generating at least one regional event weighting factor may include applying historical data from previous primary events of interest. Generating each regional event weighting factor may include applying first data and second data, wherein the first data represents an increase in popularity of the primary event of interest and wherein the second data represents a decrease in popularity of the primary event of interest. Application of the first data may be performed in a first processing system and wherein application of the second data may be performed in a second processing system, the first processing system different from the second processing system.

An event-to-spectator correlation tool may be summarized as including: a multiprocessor computing system, the multiprocessor computing system having a first processor and a second processor; at least one memory coupled to the multiprocessor computing system, the at least one memory arranged to store computer instructions executable by the first and second processors of the multiprocessor computing system, wherein the computer instructions are arranged to direct the multiprocessor computing system to: identify a gathering to view an event at a venue; determine a total possible attendance at the gathering; determine a regional popularity of the event; determine a global popularity of the event; and predict an expected attendance at the venue by cooperatively attenuating the total possible attendance based on a combination of the regional popularity of the event and the global popularity of the event.

The event-to-spectator correlation tool may include: a wide area network (WAN) communications port, wherein the computer instructions are arranged to direct the multiprocessor computing system to: communicate information about the event to a plurality of mobile devices. The first processor may determine at least one first factor that represents an increase in popularity of the event and wherein the second processor may determine at least one second factor that represents a decrease in popularity of the event. Determination of the at least one first factor by the first processor and determination of the at least one second factor by the second processor may occur in parallel. The computer instructions may be further arranged to direct the multiprocessor computing system to: multiply a first value, a second value, and a third value to produce a product, wherein the first value represents the total possible attendance, wherein the second value represents the regional popularity of the event, wherein the third value represents the global popularity of the event, and wherein the product represents the predicted expected attendance at the venue.

This Brief Summary has been provided to introduce certain concepts in a simplified form that are further described in detail below in the Detailed Description. Except where otherwise expressly stated, the Brief Summary does not identify key or essential features of the claimed subject matter, nor is it intended to limit the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 shows the relationship between a gathering and an event, as the terms are used in the present disclosure;

FIG. 2 is system that implements an event-to-spectator correlation tool embodiment;

FIG. 3 is a computing device embodiment;

FIG. 4 includes FIGS. 4A, 4B, and 4C;

FIG. 4A is a fan count data portion of a system that implements an event-to-spectator correlation tool embodiment;

FIG. 4B is an attendance data portion of a system that implements an event-to-spectator correlation tool embodiment;

FIG. 4C is a regional and global event multiplier portion of a system that implements an event-to-spectator correlation tool embodiment;

FIG. 5 is a first data flow illustrating an embodiment of a process that recursively generates an estimate of predicted attendance at a given event or gathering;

FIG. 6 is a second data flow illustrating an embodiment of a process that recursively generates an estimate of total possible attendance at a given event or gathering; and

FIG. 7 is a third data flow illustrating an embodiment of a process that recursively generates estimates of regional and global weighting factors associated with a given event or gathering.

### DETAILED DESCRIPTION

The present disclosure introduces concepts and teaching that may be further enhanced in a synergetic relationship with the invention disclosure filed on Jul. 25, 2017 in the U.S. Patent and Trademark Office, assigned U.S. patent application Ser. No. ______, and entitled EVENT-TO-SPECTATOR PREDICTION AND HOSTING TOOL, and with the invention disclosure filed on Jul. 25, 2017 in the U.S. Patent and Trademark Office, assigned U.S. patent application Ser. No. ______, entitled EVENT SPECTATOR CONNECTION TOOL, both disclosures sharing inventorship, both disclosures assigned to the same assignee, and both disclosures incorporated by reference herein to the full extent allowed by law.

The event-to-spectator correlation tool described herein provides an estimate of expected attendance at a particular event or gathering. Examples of events or gatherings of interest may be a professional sporting event, a watch-party at a bar to see a pay-per-view boxing match, a restaurant holding a themed dinner evening in correspondence with a popular television series, or any other such happening. In these cases, the sporting event stadium, the bar, and the restaurant may each benefit from a substantially accurate estimate of likely attendance at the respective venue. Along these lines, any other venue may benefit when estimated attendance at a likely event or gathering of interest can be determined accurately. For example, using the estimate, the venue can better plan food, drinks, staffing, security, merchandise, and any other attendance-based product or service provided by the venue.

Accurate estimates of likely attendance to an event or gathering can be beneficially used in other ways as well. For example, if the popularity of a particular primary event (e.g., a sporting event, an artistic endeavor, a concert, or the like) can be determined in a particular geographic location, then such information can be used to direct advertising by a particular venue, fans of the primary event can be directed to a particular venue, and the goods and services of a particular venue can be matched to a prospective group of fans. Other benefits and uses for accurate estimates of likely attendance at a particular event or gathering have also been contemplated.

The present invention may be understood more readily by reference to this detailed description of the invention. The terminology used herein is for the purpose of describing specific embodiments only and is not limiting to the claims unless a court or accepted body of competent jurisdiction determines that such terminology is limiting. Unless specifically defined herein, the terminology used herein is to be given its traditional meaning as known in the relevant art.

Prior to setting forth additional details, it may be helpful to an understanding of the present disclosure to first set forth certain terms that are used hereinafter.

Activity. The term “activity” is used, in all of its grammatical constructs, throughout the present specification and claims, to refer to an organized program of an entity in which a venue participates. An activity includes, but is not limited to, a competition; a charity; an auction; a promotion; and the like. A non-limiting, non-exhaustive list of activities includes engagement in any type of sport, meetup, party, pursuit, hobby, pastime, interest, diversion, distraction, occupation, job, work, act, deed, project, scheme, task, venture, enterprise, endeavor, undertaking, or any other type of avocation.

Affiliate. The term “affiliate” is used, in all of its grammatical constructs, throughout the present specification and claims, to refer to a defined association or interest in a particular subject. An affiliate includes, but is not limited to, an actor; an actress; an author; a musician; any one or a combination of an in-person, board, video, and augmented-reality game; a region; a recognized government entity of any country, state, city, or municipality; any one or a combination of a school, a college, and a university, or other institution of learning; a union; a sports team; a league or other defined controlling body of organized competitive events; an athlete; any one or more of a political party, political action committee, or organized political interest; a public, private, or semi-private social club; and the like.

Auction. The term “auction” is used, in all of its grammatical constructs, throughout the present specification and claims, to refer to a sale of one or more goods, services, or goods and services by competitive bid. For example, an auction may include a bidding system wherein venues place competitive monetary bids to try to win a thing of value, such as the right to host a gathering wherein one or more venues placing the highest monetary bid or bids, as the case may be, is declared the winner. An auction, which may also be referred to as an auction system, is administered via a cooperative collection of automated, manual, or automated and manual processes that accept input data, execute calculations, present one or more auction offerings, accept bids, and determine a winner.

Computational Model. The term “computational model” is used, in all of its grammatical constructs, throughout the present specification and claims, to refer to a mathematical or computing model which takes inputs, performs calculations, and provides an estimate of expected behavior within a complex system. As the term is used herein, a computational model may be embodied in software, hardware, or a combination of software and hardware.

Eligibility Criteria. The term “eligibility criteria” is used, in all of its grammatical constructs, throughout the present specification and claims, to refer to any one or more of requirements, restrictions, conditions, qualifications, and other such standards that a venue must meet to successfully bid in and win an auction to host a gathering. Non-limiting examples of eligibility criteria include, but are not limited to, size, fire capacity, location, proximity to a sufficient number of participants with a relevant affiliation, and the like.

Entity. The term “entity” is used, in all of its grammatical constructs, throughout the present specification and claims, to refer to any one or more of a business, a corporation, an association, a partnership, a company, a firm, a venture, a trust, a proprietorship, a group, and a person with legal standing. An entity, as used herein and in accordance with the relevant context, includes a human or digital representative acting on behalf of the entity.

Event. The term “event” is used, in all of its grammatical constructs, throughout the present specification and claims, to refer to any live (in-person), broadcast, or recorded activity that is supported by, promoted, conducted, or otherwise directed by an entity. An event is a primary person, place, or thing that draws attention. An event includes, but is not limited to, any sporting contest, game, match, set, or competition; a meetup before and after a live sporting event near a stadium; a television (TV) show; an award show; a political broadcast such as a political debate; any other live or recorded broadcast via wired or wireless means such as TV, Internet, radio, and the like; an alumni, fraternal, or other like gathering of people; a company, product or service launch, or other business-focused special event party; a trivia night; a relationship/date night; a bar crawl; a game night; a LAN party; a board game night, card night, dice night, or other such night; a theme, holiday, or other special event party; and any other like activity. In some cases, a secondary event is a gathering of people whose attention is drawn to a primary event. In some of these cases, for example, a secondary event is an assembly of people having a common interest or affiliation who gathered in a particular physical location for planned or unplanned activity associated with that common interest or affiliation.

Event Attendance. The term “event attendance” is used, in all of its grammatical constructs, throughout the present specification and claims, to refer to an estimate of the number of persons in a given region who will attend at least one of a particular event and a particular gathering.

Event Data. The term “event data” is used, in all of its grammatical constructs, throughout the present specification and claims, to refer to input variables used in a computational model. Event data may include, but is not limited to, third-party data; sports & electronic sport (esport) event data; any one or more of live, broadcast, and recorded viewing data. Event data may also include wildcard factors, which are event data encountered by the particular computational model for the first time. To this end, wildcard factors may be used a single time in the computational model or, in some cases, one or more wildcard factors become established event data that is used additional times in future executions of a computational model.

Event Partner. The term “event partner” is used, in all of its grammatical constructs, throughout the present specification and claims, to refer to a third-party entity contracted to provide determined goods, services, or goods and services, that are intended to enhance spectators' experience at an event or gathering. A non-limiting, non-exhaustive list of goods and services that an event partner may provide includes: hospitality items, tickets, access to activities, media, memorabilia, merchandise.

Event Popularity. The term “event popularity” is used, in all of its grammatical constructs, throughout the present specification and claims, to refer to an estimate of how many spectators in a particular region will be interested in attending one or more of a particular event and a particular gathering.

Gathering. The term “gathering” is used, in all of its grammatical constructs, throughout the present specification and claims, to refer to an assembly of people having a common interest or affiliation in an event coming together at a particular venue. In some cases, a gathering itself is a type of an event. For example, a given event may be a happening of primary focus, and a gathering may be a secondary event arranged to assemble people as spectators to the primary event.

Host. The term “host,” in all of its grammatical constructs, throughout the present specification and claims, may be used as either a noun or as a verb, based on its context or usage. A non-limiting example of the term “host” used as a noun includes an “event host” that is an individual, a business, an organization or some other legal entity able and willing to administer or otherwise direct an event or gathering. In this way, a host (e.g., an event host) may also include a human or digital representative acting on behalf of the host. A non-limiting example of the term “host” used as a verb includes a venue “hosting” an event or gathering by inviting spectators into the venue and providing goods, services, or goods and services such as entertainment, viewing parties, multimedia delivery, beverages, food, and the like, sometimes for a fee.

Network. The term “network” is used, in all of its grammatical constructs, throughout the present specification and claims, to refer to a digital platform administered by an entity, wherein the entity acts to connect participants, organize gatherings at venues, or connect participants and organize gatherings at venues. For example, a network may be, without limitation or exhaustion, a fan club, a social network, a group or sub-group within a social network, a team, a congregation, a collection of alumni, a collection of current or former employees, a group of students of a particular institution, and the like.

Network Group. The term “network group” is used, in all of its grammatical constructs, throughout the present specification and claims, to refer to a combination of participants associated with a same geographic region; the participants having a common interest or affiliation.

Participant. The term “participant” is used, in all of its grammatical constructs, throughout the present specification and claims, to refer to a living human spectator or a digital persona spectator (e.g., an “avatar”) interested in attending an event or interested in attending a gathering based on one or more affiliations.

Region. The term “region” is used, in all of its grammatical constructs, throughout the present specification and claims, to refer to any defined or definable geographic area. A region may include, but is not limited to, any one or more of the entire world; a country; a state of the United States or a Canadian province; a county; a city; a district; a zip or postal code; a neighborhood; a street or group of streets; an intersection; a business location; an Internet protocol (IP) address; a set of global positioning system (GPS) coordinates, and a specific street address or any group of two or more of the foregoing.

Regional Factors. The term “regional factors” is used, in all of its grammatical constructs, throughout the present specification and claims, to refer to input variables applied in a computational model. Regional factors may include, but are not limited to, conflicting happenings and occurrences; economic factors; human, social, and other demographic factors; political factors; third-party data; regional demographic factors; time of day; duration or other length of a particular event; unplanned acts; and weather. Regional factors may also include wildcard factors, which are input variables encountered by the particular computational model for the first time. To this end, wildcard factors may be used a single time in the computational model or, in some cases, one or more wildcard factors become established regional factors that are used additional times in future executions of a computational model.

Spectator. The term “spectator” is used, in all its grammatical forms, throughout the present specification and claims, to refer to any human being that is interested in a particular determined event. Without limitation, a spectator may be any one or more of a fan, enthusiast, admirer, supporter, critic, backer, devotee, addict, aficionado, attendee, citizen, resident, party-member, follower, voter, investor, employee, supervisor, supplier, customer, stakeholder, viewer, watcher, onlooker, bystander, witness, observer, juror, and the like.

Venue. The term “venue” is used, in all of its grammatical constructs, throughout the present specification and claims, to refer to a business, an organization, or another legal entity that is able and willing to host an event. Examples of a venue include, but are not limited to, a retail store, a private residence, a restaurant, a bar, a nightclub, a mall or another retail establishment, a museum, an auditorium, an office building or complex, a garage, a field, an amphitheater, a theater, a stadium, a course, an airport, a hotel, a motel, a public meeting room, a domicile, a park, a field, a website, and any digital platform such as a social network (e.g., FACEBOOK, LINKEDIN, TWITTER) or subgroup therein. A venue, as used herein and in accordance with the relevant context, includes a human or digital representative acting on behalf of the venue.

Viewing. The term “viewing” is used, in all of its grammatical constructs, throughout the present specification and claims, to refer to any one or more of watching, listening, feeling, or otherwise physiologically perceiving an event. Examples of viewing occur when a spectator views a live or recorded occurrence of an event in person or electronically via wired or wirelessly communicated presentation delivered though a display, a monitor, a television, a radio, a speaker, a computing device, or by another means.

### A Computational Model of Predicted Attendance at a Gathering to View an Event.

In embodiments described herein, a computational model of estimated participation (e.g., an estimated number of spectators) at a gathering to view or otherwise participate in a particular event is based on a determination of total possible attendance (TPA) at the gathering, a determination of a regional event weighting factor (REWF), and a determination of a global event weighting factor (GEWF). Along these lines, participation (e.g., spectator attendance) in the particular gathering may be estimated according to the formula in Equation 1.

Expected_Attendance=(TPA)×(REWF)×(GEWF) (1)

wherein,
TPA=Total Possible Attendance;
REWF=Regional Event Weighting Factor; and
GEWF=Global Event Weighting Factor.

In Equation 1, Total Possible Attendance (TPA) is an integer, and the Regional Event Weighting Factor (REWF) and Global Event Weighting Factor (GEWF) are real numbers normalized between 0.0 and 1.0.

By way of example only, a celebrity tennis match in Boston is a particular event scheduled for a particular day. By way of example only, two celebrities playing in the celebrity tennis match each have 4000-member Boston-based fan clubs, and the United States Tennis Association (USTA) has 5000 members in the Boston area. Further by way of example only, it is known that 25 percent (25%) of the members of each fan club are also members in both fan clubs (i.e., 1000 common fan club members), and it is known that 12.5 percent (12.5%) of each fan club's members are USTA members and members of only one fan club (i.e., 500+500=1000 common fan club and USTA members). According to this example, it can be determined that the Total Possible Attendance (TPA) to the celebrity tennis match may be determined to be 10,000 people, which is a sum derived by the number of unique fans in each of the two celebrity fan clubs (i.e., 3,500+3,500=7,000) plus the number of unique USTA members that are not in either fan club (i.e., 3000).

Recognizing that an expected attendance is very frequently less than a total possible attendance, the inventors here have created a novel tool to predict an expected attendance with substantial accuracy. Considering the example of the celebrity tennis match in Boston, to determine an expected attendance, the Total Possible Attendance (TPA) of 10,000 people may be reduced by a combination of a regional event weighting factor (REWF) and a global event weighting factor (GEWF). In this example, if the REWF is determined to be 0.5, and if the GEWF is determined to be 0.8, then the expected attendance at the celebrity tennis match in Boston can be estimated as in Equations 2 and 3.

Expected_Attendance=(TPA)×(REWF)×(GEWF) (2)

4,000=(10,000)×(0.5)×(0.8) (3)

wherein,
TPA=10,000;
REWF=0.5; and
GEWF=0.8.

In embodiments described herein, the computational model of predicted attendance at a particular event may be based, at least in part, on an estimate of total possible attendance (TPA) adjusted according to an estimate of regional event weighting factors. The regional event weighting factor (REWF) that is applied to the TPA in the computational model may be considered to be an estimate of the regional popularity of the particular event.

Also in embodiments described herein, the computational model of predicted attendance at a particular event may be based, at least in part, on further adjustment to the TPA estimate according to an estimate of global event weighting factors. The global event weighting factor (GEWF) estimate that is applied to the TPA in the computational model may be considered to be an estimate of the global popularity of the particular event.

Considering the celebrity tennis match in Boston that is exemplified in Equation 2 and Equation 3, factors that contribute to the estimate of total possible attendance (TPA), factors that contribute to the estimate of regional popularity (i.e., REWF), and factors that contribute to the estimate of global popularity (i.e., GEWF) are now introduced.

### The Estimate of Total Possible Attendance (TPA).

The estimate of total possible attendance at, to, or otherwise associated with a particular gathering to view a particular event represents a determined total number of spectators that may possibly attend or otherwise participate in the particular gathering.

When a calculated or otherwise determined “number” of spectators is discussed relative to a given event, the number represents an attempt by the system to identify a unique number of spectators. By way of example only, if the number of spectators at a given sporting event (e.g., a Boston College hockey game) is determined to include graduates of a certain college (e.g., Boston College) and amateur members of a certain sport (e.g., USA Hockey), then people who are both graduates of the certain college and amateur members of the certain sport (e.g., USA Hockey members who graduated from Boston College) are desirably only counted once (i.e., counted as a member of both groups), and not counted twice (i.e., counted once as a member of one group and counted again as a member of another group).

A total possible attendance (TPA) value is generally formed by establishing an initial starting value and copying the initial starting value into a temporary working variable called a total possible attendance (TPA) working variable. The TPA working variable is then adjusted to add additional spectators and to remove doubly-counted spectators. The initial starting value for a TPA working variable may in some cases be zero. In other cases, the initial starting TPA working variable may be an estimate of total possible attendance based on reports from an event organizer, reports from a news or other reporting source, historical data from a previous occurrence of the same or similar event, or based on some other information. In some cases, the initial starting value of total possible attendance is not adjusted any further. In other cases, the initial starting value of total possible attendance is adjusted up or down by updating the TPA working variable in accordance with one or more particular attendance adjustment factors.

In many cases, the initial starting value of total possible attendance begins with a count of the total registered or unregistered participants in a particular group or network who have an affiliation relevant to the event of interest. By way of example only, if a TPA for a gathering in Huntington Beach, Calif. to watch a surfing competition is sought, then one reasonable initial starting value may be the number of amateur surfers who entered amateur surfing competitions at Huntington Beach in the previous 10 years.

The initial starting value loaded into the TPA working variable may come from any number of sources. In some cases, the TPA working variable is not adjusted any further. In other cases, the TPA working variable may be adjusted up or down by a set of one or more attendance adjustment factors. If the initial starting value loaded into the TPA working variable is further adjusted, the adjustments are based on information from a set of attendance adjustment factors.

Non-exclusively, and non-exhaustively, the set of attendance adjustment factors may include, but are not limited to, any one or more of 1) event-data, 2) number-of-estimated-participants, 3) number-of-registered-participants, 4) participant-data, 5) regional-data, 6) third-party-data, and 7) wildcard factors.

Event-data attendance adjustment factors may include data from gathering organizers, event organizers, electronic sources, and other event-based sources. The event data can establish an initial pool of spectators to an event (e.g., people who traditionally attend the Indianapolis 500 race, people who regularly attend the Kentucky Derby horse race, party members who are delegates to a national political convention, and the like. The event data can also adjust a TPA working variable by adding additional spectators, removing duplicate spectators, or make other adjustments.

Number-of-estimated-participants attendance adjustment factors can represent people who have an affiliation relevant to the given event of interest. The number-of-estimated-participants factor may include fan club members, college boosters, donors, past attendees of the same or similar events, or some other estimate.

Number-of-registered-participants attendance adjustment factors account for spectators that are currently registered for the event or gathering of interest. The number-of-registered-participants attendance adjustment factor may be received from any one or more of an event organizer, a gathering organizer, a venue, a ticket brokerage service, a self-reporting website, a publicly available list, and the like. Like some or all of the other factors described herein, the number-of-registered-participants attendance adjustment factor may be updated randomly, expectedly, unexpectedly, or at a particular rate. Along these lines, the number-of-registered-participants attendance adjustment factor, like some or all of the other factors described herein, may be used in a feedback loop to update a value used in the computational model.

Participant-data attendance adjustment factors may include attendance data gathered by direct advertising, in-person events or gatherings organized to reach targeted potential spectators, direct postal and electronic mail campaigns, purchased customer lists, and the like. Participant-data attendance adjustment factors may be arranged to cross reference other attendance adjustment factors such that spectators are counted one time and not multiple times.

Regional-data attendance adjustment factors are arranged to account for regional adjustments to a pool of possible event or gathering spectators. Regional-data attendance adjustment factors may include local population numbers, venue seating capacity at the location where the gathering will be held, traffic capacity at or around the venue, event time, local weather, and the like.

Third-party-data attendance adjustment factors provide data to set or adjust a total possible attendance based on information from a third-party. Sources of third-party-data attendance adjustment factors include, but are not limited to, radio, television, and social media or other Internet sources. Third-party-data attendance adjustment factors may increase or decrease total possible attendance based on news reports, streamed comments of a “blogger” or “micro-blogger” directed to a list of “followers,” or other means.

Wildcard attendance adjustment factors adjust the total possible attendance number up or down based on data, information, or other variables not previously accounted for in the computational model. In these cases, the wildcard attendance adjustment factors are manually entered and arranged to adjust the total possible attendance estimate based on a new circumstance. When the computational model encounters such new wildcard attendance adjustment factors, a user of the computational model can create a new wildcard attendance adjustment factor, and in future uses of the model, the previously new wildcard attendance adjustment factor will continue to be available. Along these lines, embodiments of the computational model that include wildcard attendance adjustment factors as described herein are arranged to evolve and be adapted to new circumstances.

### The Estimate of a Regional Event Weighting Factor (REWF).

The estimate of the regional event weighting factor applies certain weighting inputs to an initial regional event weighting factor. In some cases, the initial regional event weighting factor is considered to be “average popularity,” which, for example, may be 0.5. Here, the computational model loads a temporary “regional” working variable with the initial regional event weighting factor, and the computational model applies a variety of regional weighting inputs. In this way, as different regional weighting inputs are applied, the temporary regional working variable evolves into the REWF. When all of the weighting inputs have been applied, the temporary variable is fully weighted, and the temporary variable is copied into or otherwise determined to be the current REWF estimate. In this way, a current estimate of an event's regional popularity is determined.

The variety of weighting inputs applied in the computational model are in some cases associated with a set of regional characteristics. Non-exclusively, and non-exhaustively, the set of regional characteristics may include local weather conditions, a local time window of the event, the local time zone, or the like. The variety of regional weighting inputs may also be based on certain affiliations of participants at the given event or gathering, such as a participant's stated preferences and the estimated popularity of the event or gathering. Accordingly, various ones of the regional weighting inputs may include, but are not limited to, any one or more of 1) conflicting factors, 2) economic factors, 3) historical participation rate factors, 4) human and social demographic factors, 5) regional demographic factors, 6) political factors, 7) time factors, 8) third-party data factors, 9) unplanned acts factors, 10) weather factors, and 11) regional wildcard factors.

Conflicting weighting factors provide adjustment to the regional event factor by taking into account other events or gatherings that conflict with the event or gathering of interest. For example, if the event or gathering of interest is a baseball game, then one conflicting factor may be a soccer game scheduled for the same time as the baseball game of interest. Conflicting weighting factors may include live events or gatherings, broadcast events or gatherings, recorded events or gatherings, and any particular happenings and occurrences that overlap or otherwise take place contemporaneously with the event or gathering of interest.

Economic weighting factors provide adjustment to the regional event factor estimate by taking financially-based information into account. Non-exhaustively, the economic weighting factors applied in the computational model may include currency exchange rates, rates of inflation, state or local tax rates, and economic stability in the region of interest. The economic weighting factors may include significant local occurrences such as layoffs at a large company.

Historical participation rate weighting factors adjust the regional event factor estimate based on previously collected data. The previously collected data may include actual attendance information from prior occurrences of the event or gathering of interest, actual attendance information at prior occurrences of similar events or gatherings, historic attendance information associated with the group of possible attendees, and other such history-based information.

Human and social demographic weighting factors may take into account age, gender, income, college education, socio-economic factors, marital status, alcohol consumption statistics, technology adoption rates, and other such data. For example, it may be determined that certain demographic rates of alcohol consumption in a particular region lead to an increase in participation at certain events or gatherings and at certain venues, while the same such information leads to a decrease in participation at other events or gatherings and venues.

Regional demographic weighting factors may also be applied to generate the regional event factor estimate. Regional demographic weighting factors may, for example, include information representing rurality, urban density, density of alcohol establishments, numbers of schools per geographic area, quality of schools, numbers of religious institutions per geographic area, regional tourism, traffic congestion, commuting options, and the like.

Political weighting factors may be used to adjust the estimated regional event factor. Political factors may include statistical voting records, statistical voting rates, campaign information, party affiliation statistics, political uncertainty, and other such information.

Time weighting factors may include the time of day that the event or gathering of interest takes place, the day of the week, and other date information such as holidays and vacations. Time weighting factors account for changes in human behavior based on when a particular event or gathering of interest takes place.

Third-party data weighting factors are arranged with respect to collected data regarding expected attendance or viewership of the event or gathering of interest from sources such as, but not limited to, television, social media, or other third-party sources. The information that influences the third-party data weighting factors may be mined from public sources, retrieved from private-party sources, provided by contracted third parties, or acquired in different ways.

In some cases, the regional event factor estimate is adjusted based on weighting factors associated with unplanned acts. The unplanned acts may be acts of nature such as significant storms, tornadoes, earthquakes, and the like. The unplanned acts may also be associated with war, terrorism, protests, sudden unavailability of a venue, changes to regulations, unplanned visits from foreign or domestic dignitaries, or other such unplanned occurrences.

Weather weighting factors may include recent weather phenomena, current weather, future weather, weather patterns, and the like. The weather episodes may be associated with temperature, precipitation, humidity, certain insect infestations, storm-based effects such as dust or lightening, and other weather circumstances.

Wildcard weighting factors provide adjustment to the regional event factor estimate by taking into account other circumstances that have not previously been accounted for in the computational model. In these cases, the wildcard weighting factors are manually entered and arranged to adjust the regional event factor estimate based on a circumstance the computational model has not previously encountered. For example, if the event of interest is a physics consortium, and if an invited participant of the consortium announces discovery of a perpetual motion machine, then it might reasonably be expected that attendance and popularity of the physics consortium event will increase. Because the computational model does not currently account for a perpetual motion wildcard factor, a user of the computational model can create such a wildcard weighting factor, and in future uses of the model, such a weighting factor will be available. Along these lines, embodiments of the computational model described herein are arranged to evolve and be adapted to new circumstances.

### The Estimate of a Global Event Weighting Factor (GEWF).

The estimate of the GEWF applies certain weighting inputs to an initial global event weighting factor. The initial global event weighting factor is, in some cases, considered to be “average popularity,” which, for example, may be 0.5. Here, the computational model loads a temporary “global” working variable with the initial GEWF, and the computational model applies a variety of global weighting inputs. In this way, as different global weighting inputs are applied, the temporary global working variable evolves into the global event weighting factor (GEWF) estimate. When all of the weighting inputs have been applied, the second temporary variable is fully weighted, and the second temporary variable is copied into or otherwise determined to be the current GEWF estimate. In this way, a current estimate of an event's global popularity is determined.

A second variety of weighting inputs is applied in the computational model, which are in some cases associated with a set of global characteristics. Non-exclusively, and non-exhaustively, the set of global characteristics may include, but are not limited to, any one or more of 1) type-of-event factors, 2) nature-of-event factors, 3) status-of-individual-event-participant factors, 4) current-and-historical-performance factors, 5) calculated-or-estimated-excitement/engagement-level factors, 6) estimated electronic-or-live-viewing-attendance factors, 7) third-party-data factors, and 8) global-wildcard factors.

Type-of-event weighting factors adjust the global event weighting factor (GEWF) estimate based on characteristics of the particular event of interest. For example, higher type-of-event weighting factors may be assigned for National Football League (NFL) games, and lower type-of-event weighting factors may be assigned for National Lacrosse League (NLL) games and Professional Bowling Association (PBA) matches. Higher weighting factors may be assigned for live sporting events, and lower weighting factors may be assigned for broadcasts of previously recorded sporting events. Higher weighting factors may be assigned for a third political debate, and lower weighting factors may be assigned for a first political debate. Higher weighting factors may be assigned for a competitive event, and lower weighting factors may be assigned for a non-competitive event. Along these lines, determinations of any particular type-of-event weighting factors may initially be manually entered values; and determinations of any particular type-of-event weighting factors may initially be very subjective. As use of the computational model progresses over time, the results of one or more computations are analyzed against actual results, and one or more weighting factors may be manually or automatically adjusted.

Nature-of-event weighting factors operate to increase or decrease the global event weighting factor (GEWF) estimate. Examples of such weighting factors include, without limitation or exhaustion, a time of the season (e.g., pre-season, regular season, post-season, championship, tournament, series finale, repeat television episode, first debate, final debate, and the like). Other such examples include “in-event” weighting factors. For example, an event featuring two sports teams in the same conference may be assigned a higher weighting factor, and an event that features teams in different conferences may receive a lower weighting factor. Events that feature rivals (e.g., sports rivals, political opponents, and the like) may have assigned thereto higher weighting factors than events that have individual participants or non-rivals.

Status-of-individual-event-participant weighting factors are applied to increase or decrease the effect of the global event weighting factor (GEWF) estimate based on information associated with individual participants in the particular event. For example, injuries to particular participants may decrease weighting factors, and notable player, coach, or other participant matchups (e.g., Lebron versus Kobe) may increase weighting factors. As another example, when an event features a participant that is on the cusp of achieving a milestone (e.g., a homerun record, a football passing yards record), the weighting factor may increase, and when the event features a participant that has publicly offended a particular audience with a certain behavior or comment, the weighting factor may decrease.

Current-and-historical-performance weighting factors may represent adjustments to the global event weighting factor (GEWF) estimate based on wins, losses, ties, ranking, position in standings, milestones, Nielson ratings, history performance of time-slot, and other such factors.

Calculated-or-estimated-excitement/engagement-level weighting factors adjust the global event weighting factor (GEWF) estimate based on individual or group excitement in a particular event. For example, a playoff or championship event for a team of a particular city will typically be assigned a higher weighting value, and a late-season game for an out-of-contention team will often be assigned a lower weighting value. Early-card fights in a boxing match will generally have lower weighting factors than fights scheduled later on the event card, and season-ending episodes of a certain television series will generally have a higher assigned weighting factor than mid-season episodes.

Estimated-electronic-or-live-viewing-attendance weighting factors may be derived from third-party data such as Nielson Ratings, advertising cost information, and the like. In this set of weighting factors, the global event weighting factor (GEWF) estimate can be adjusted based on an estimated or otherwise determined number of electronic or live viewers of the particular event. For example, if a local sports team expects to sell out seats at its stadium for a particular game or match, then the weighting factor for an event that displays the particular game or match (e.g., broadcast of the particular game or match on video screens of a bar or restaurant) may be increased. Along these lines, if a local sporting event will not be televised locally, then a weighting factor directed toward physical attendance at the live event may be increased.

Third-party-data weighting factors may increase or decrease one or more particular weighting factors based on expected attendance, viewership, or other participation derived from a third-party source. One source of third-party data may include social media. Another source of such data may be television. Yet another source of third-party data may be a private aggregator of information associated with the event, a gambling “tip” service, or an Internet-based fantasy league. Other sources of third-party data are also contemplated.

Global-wildcard weighting factors provide adjustment to the global event weighting factor (GEWF) estimate by taking into account still other events and circumstances that have not previously been accounted for in the computational model. In these cases, the global-wildcard weighting factors are manually entered and arranged to adjust the global event weighting factor estimate based on a circumstance that the computational model has not previously encountered. Because the computational model does not currently account for such a global-wildcard weighting factor, a user of the computational model can create such a global-wildcard weighting factor, and in future uses of the model, such a global-wildcard weighting factor will be available. Along these lines, embodiments of the computational model that include global-wildcard weighting factors as described herein are arranged to evolve and be adapted to new circumstances.

In some cases, the concepts described herein to generate an estimate of expected attendance at a given event or gathering may be used for different or additional purposes. For example, an estimate of expected attendance at a given event or gathering may be used to facilitate an event-to-spectator prediction and hosting tool. One embodiment of such a tool can apply an estimate of expected attendance at a given event or gathering to estimate a determined optimal number of venues to host an event or gathering, along with their geographic placement within a region. In these or in alternative cases, after generating the estimate of a determined optimal number of venues to host an event or gathering, the estimate is used to support a bidding system wherein prospective venues compete to win an opportunity to host an event or gathering, and the expected attendance may influence the value that the prospective venue places on the opportunity.

In the cases where a determined optimal number of venues to host an event or gathering is estimated, the estimate is directed toward an event or gathering in a determined region. Examples of a determined region include a country, a region, a state, a county, a municipality, a postal code, a group of any of the foregoing geographic designations, or some other geographic region. In the preparation of an estimate of a determined optimal number of venues to host an event or gathering, a variety of inputs are used in the computational model. The variety of inputs may be directed to spectators, venues, geographic regions, or some combination thereof. The variety of inputs may include particular spectator characteristics, numbers of determined spectators in a determined region, density and location of prospective spectators, and other such information.

In some cases, a system that generates an estimate of a determined optimal number of venues to host an event or gathering is arranged as a computational model embodied in hardware, software, or a combination of hardware and software. The computational model applies a plurality of weighted inputs and carries out a plurality of associated calculations. Using the weighted inputs and associated calculations, which may be based on spectator data, venue data in a given geographic region, and the geographic region itself, the computational model will produce an output that estimates a determined optimal number of spectators within a given geographic region.

In some cases, a competitive bidding system is implemented. In embodiments of such a system, venue hosts compete to win an opportunity to host a given event or gathering for a determined group of spectators in a determined geographic area. The computational model in these cases is used to calculate a determined optimal number of events or gatherings and corresponding geographic placement of the events or gatherings. For each determined event or gathering in a corresponding geographic area, a bidding competition is established and executed. The computational model takes in a variety of inputs. The inputs include a determined number of spectators, a determined one or more eligible venue hosts, one or more corresponding determined geographic areas, and the count, density, and location of spectators having a relevant common interest or affiliation.

According to some embodiments of the computational model, a competitive bidding platform will only accept bids from a determined set of eligible host venues. In these cases, each prospective host venue will satisfy one or more eligibility characteristics. The one or more eligibility characteristics of a given venue host may include proximity to a sufficient number of spectators having a common interest or affiliation, hours of operation, seating or other guest capacity, electronic presentation facilities (e.g., subscription package, number, and location of televisions, displays, sound systems, and the like), and other such characteristics. After a prospective venue host wins a contest to host an event or gathering, the venue host pays the agreed amount, and a particular event or gathering is planned and executed. In association with winning the contest, the computational model may promote the given event or gathering via secondary automation. Secondary automation may include promotion via one or more digital platforms (e.g., electronic mail, social network, digital text message, seeding search engine optimization (SEO) search terms, and the like). Such promotion is organized to increase in-person attendance at the event or gathering.

A computational model that implements an event-to-spectator prediction and hosting tool may be provided with algorithmic logic as described herein. The algorithmic logic of tool includes weighted inputs and associated calculations, which are based on data that may include any one or more of spectator data, venue data in a given geographic region, and the geographic region itself. Using the input data, the computational model produces an output that estimates a determined optimal number of spectators within a given geographic region. In other words, an estimated number of spectators can be analyzed based on a plurality of different and differently sized geographic regions. The analysis is arranged to estimate a determined optimal number of venues within a geographic region that should be selected to host an event or gathering.

Many weighted and other inputs are applied in embodiments of an event-to-spectator prediction and hosting tool. Each of the inputs may be optional, and in some cases, where such an input is not provided, a hard-coded or otherwise fixed value may be used in place of the input. A first input to an event-to-spectator prediction and hosting tool represents a location-of-affiliation-spectators. The location-of-affiliation-spectators represents a geographic location of spectators in a given region. In some cases, the location-of-affiliation-spectators may represent or otherwise be applied to determine a distribution of spectators in a given region. The distribution of spectators have a common interest or other type of affiliation or common interest relevant to a given event or gathering.

A second input to an event-to-spectator prediction and hosting tool represents a location-or-distribution-of-spectators to a particular event or gathering within a given geographic region. A third input represents the specific location-or-distribution-of-venues within a given geographic region. The locations or distributions of spectators, venues, and the like may be stored in any one or more of a database, a computer data structure, one or more variables, or another type of structure.

Fourth, fifth, and sixth inputs to an event-to-spectator prediction and hosting tool represent, respectively, a number-of-affiliated-spectators, a number-of-spectators, and a number-of-venues. A number-of-affiliated-spectators represents a count of spectators in a given geographic region wherein each of the counted spectators has an affiliation or common interest of relevance to a given event or gathering. A number-of-spectators represents a count of spectators located within a given geographic region. And a number-of-venues represents a count of venues located within a given geographic region.

A seventh input to an event-to-spectator prediction and hosting tool represents a size-of-venues value. In other words, the seventh input represents a count of the number of spectators that can attend, view, or otherwise participate in an event or gathering a particular venue based on the capacity of the particular venue. In some cases, one or more size-of-venues values may be stored for each venue in a determined geographic region.

When the computational model of the event-to-spectator prediction and hosting tool operates, the algorithmic logic loops through any number of determined regions. More specifically, the algorithmic logic may loop through any number of states, counties, cities, towns, postal codes, street addresses or any geographic area or combination of geographic areas. To perform this looping task, a particular geographic area of interest may first be defined (e.g., a city, a region of several adjacent cities, a postal code, a collection of adjacent postal codes, or the like). Then, within the particular geographic area of interest, any number of sub-areas of interest are defined. In one example, a particular geographic region of interest is a city, and at least some of the sub-areas of interest include each individual postal code in the city, pairs of postal codes in the city, certain city blocks or groups of city blocks, and so on. For each one of the identified sub-areas, a determined optimal number of events or gatherings may be generated. Subsequently, upon analysis of the generated data for each sub-area, the algorithmic logic may determine corresponding geographic placement of one or more events or gatherings. In some cases, when the number of determined spectators in a geographic area of interest is larger than a determined threshold, the boundaries of the geographic area of interest are changed (e.g., reduced). In some cases, when the number of determined spectators in a geographic area of interest is smaller than a determined threshold, then one or more sub-areas may be combined, or the boundaries of the geographic area of interest may be changed (e.g., increased).

After the algorithmic logic of the event-to-spectator prediction and hosting tool determines one or more estimates of expected attendance at a given event or gathering within a defined region, the algorithmic logic will determine whether there are enough estimated spectators to approve one or more venues to host an event or gathering to serve the defined region. As a result, any given geographic region may be determined eligible to host zero, one, or more events or gatherings. Alternatively, a plurality of geographic regions may be determined eligible to host zero or one event or gathering across all of the geographic regions of the plurality.

To better illustrate certain concepts described herein, one non-limiting exemplary algorithmic logic applied in an embodiment of an event-to-spectator prediction and hosting tool is now described. In the example, a professional football game is a primary event of interest.

Certain fictional details regarding the exemplary football game are now provided to help assist in an understanding of the event-to-spectator prediction and hosting tool. In this example, the current day is a day in late January, and the professional football game is to be played several days in the future, in Dallas, Tex. One of the professional football teams is from Foxboro, Mass. and the other of the two teams is from Green Bay, Wis. The football game is the final game of the season, and the winner of the football game will be declared the world champion football team for that year.

To further supplement the hypothetical professional football game example, various exemplary estimates of expected attendance at one or more “viewing parties” (i.e., a viewing party may be considered an event or a gathering) in and around Seattle, Wash. are considered. Because the exemplary professional football game is the final game of the season, and because there are many professional football fans in the geographic areas in and around Seattle, Wash., it is believed that many of these football fans will be interested in attending a viewing party event or gathering. Along these lines, an event-to-spectator prediction and hosting tool can be used to fill one or more bars or restaurants to a determined optimal level, and the spectator prediction and hosting tool can also be used to direct certain ones of these Seattle-based football fans to one or more viewing parties that are particularly suited to their interest.

In summary of the present example, the event-to-spectator prediction and hosting tool is embodied as an auction system that allows venues to bid to host an event or gathering (i.e., a viewing party) associated with the final professional football game of the season. The auction platform is configured in the present example to only allow a venue to place a bid in an auction if that venue meets certain requirements of proximity to a sufficient number of spectators (i.e., an estimated number of expected attendees) having a relevant affiliation. In some cases, the relevant affiliation for auctions in the present example may be spectators in fan groups associated with the team from Green Bay, Wis.; spectators in fan groups associated with the team from Foxboro, Mass.; fan groups of funny commercials (i.e., commercials televised during play stoppages of the final football game of the season, and the like), and any other affiliation or common interest.

Each auction created in association with the present professional football game example is created using various weighted inputs and associated calculations. Each auction will operate and run as a multi-user system with particular bidding functions. The inputs to the auction system may include, but are not limited to, a location-of-venues, which is the specific location of a venue or number of venues within a given region; a number-of-venues, which is a count in the present example of the venues located within a given geographic region; and a placement-of-venues, which is a list of locations of all venues across a given geographical region.

Operations of the event-to-spectator prediction and hosting tool in the present professional football game example are further summarized. Here, it is noted that a geographic region in and around the Seattle, Wash. area may have zero, one, or more viewing parties (i.e., events or gatherings). It is also noted that multiple geographic regions around Seattle may have only one venue hosting a single viewing party (e.g., event or gathering) across all of the given geographic regions under analysis. Based on the inputs provided to the event-to-spectator prediction and hosting tool, zero, one, or multiple “viewing parties” (e.g., events or gatherings) may be auctioned off. Here, the auction creation process may be automatic or manual. Venues must meet and sustain certain eligibility requirements to be allowed to bid in and win an open auction. In addition, bidding for each auction will be open for a certain period of time, and at the end of the auction, the highest bidder or bidders will be the winner or winners of the auction. Based on winning, the auction winner may gain certain rights to interact with certain ones of the spectators.

Considering the same exemplary professional football game used in an earlier described summary herein, an embodiment of the event-to-spectator prediction and hosting tool is now described in more detail. Here, the auction system embodied in the event-to-spectator prediction and hosting tool may be executed by a scalable, distributed web service, accessible via the Internet, and which includes a portal for users to access, business logic, application logic, and any number of database structures. The auction system will be accessible by any type of computing device having access to the Internet.

In the present example, processes of the event-to-spectator prediction and hosting tool may be separated into a plurality of defined acts. Certain regularly scheduled validation and cleanup tasks are not described. Other tasks are described in detail. A first act includes an importation or some other acceptance of data into the computational model (e.g., acceptance of data associated or otherwise relevant to the professional football game and the estimate of possible spectators to events associated with the professional football game of interest); a second act includes placement calculations for the event or gathering (e.g., determinations of how many viewing parties for the professional football game can be held, determinations of themes for the viewing parties to attract fans having common interests, and a distribution of venues where the viewing parties can be held); a third act includes creation of one or more auctions, (e.g., to permit a plurality of venues to bid on viewing parties in a geographic area served by the venues); a fourth act includes bidding in the one or more auctions by prospective venue hosts; a fifth act includes payment from each winning bidder venue host (i.e., from each winner of an auction to host a particular viewing party); and a sixth act includes creation of the event or gathering and secondary automation to direct relevant spectators to the created event (e.g., promotion and execution of the viewing party of the professional football game).

Each of the acts of the event-to-spectator prediction and hosting tool processes associated with the exemplary professional football game primary event is now described in more detail.

The first exemplary act in a process of the event-to-spectator prediction and hosting tool in the context of the professional football game example is considered. In the first act, information associated with the primary event is imported into the computation model. The input data associated with the professional football game of the present example may include a day, date, time, and location of the professional football game. Data regarding the teams playing in the professional football game along with data regarding any number of individuals associated with the teams can be entered. Background information of any type associated with the teams, players, coaches, and the like can be entered. Other administrative information such as won/loss records, standings, and other such descriptive data can be entered. Information directed to records, rivalries, and the like can be entered, and a designation of the playoffs/championship of the exemplary football game can be entered along with a designation of post-season play, conferences of both teams, and any other data associated with the professional football game can be entered.

The data entered into the computational model can be added to any one or more database structures of the event-to-spectator prediction and hosting tool through any number of methods. For example, the data can be entered automatically via importation from a data feed of a sports-data third-party service provider. Data can also be entered manually via adding individual events or gatherings through a user-facing portal. Data that is stored into any type of database structure associated with the event-to-spectator prediction and hosting tool may be available as needed, and some or all of such data may be refreshed recursively.

The second exemplary act in a process of the event-to-spectator prediction and hosting tool in the context of the professional football game example is considered. Particularly, event placement calculations associated with the professional football game are considered.

In some embodiments, the computational model of the event-to-spectator prediction and hosting tool includes algorithmic logic that takes in and applies various weighted inputs and associated calculations. Using those weighted inputs and associated calculations, which are based on certain data regarding spectators at viewing parties around the professional football game and venue hosts in a given region around Seattle. Data associated with the region in or around Seattle is also considered. Here, the computational model will produce an output that includes a determined optimal number of events or gatherings (i.e., football viewing parties in a particular area around Seattle that attract spectators to view the championship football game.

Inputs to the computational model are directed toward data associated with the championship professional football game in the present example. The inputs may include, but are not limited to, a location of affiliation spectators (e.g., the location, distribution, or location and distribution of spectators in a given geographic region with any one or more affiliations relevant to the professional football game primary event); a given event (i.e., the professional football game); a location of spectators (e.g., a location, distribution, or location and distribution of spectators within a given geographic region); a location of venues or venue hosts (e.g., a specific location of a venue or a number of venues within a given geographic region in and around the Seattle area); a number of affiliated spectators (e.g., an estimated possible number of attendees of the professional football game grouped by affiliation, such as a Green-Bay-Football-Fans-In-Seattle networking group); a number of spectators (e.g., a count of all professional football fans/spectators in and around Seattle); a number of venues (e.g., a count of preliminarily eligible venues in and around Seattle); and a size of each venue (e.g., a count of the number of spectators that can attend a viewing party for the professional football game based on the capacity of the given venue).

Next in the second act, the algorithmic logic will loop through each defined geographic region (e.g., loop through each geographic area in and around Seattle based on city boundaries, postal code, groups of postal codes, and the like). Based on the inputs, the algorithmic logic will perform any number of calculations to determine whether there are enough spectators to validate if any one or more venues are eligible to host an event or gathering (e.g., a viewing party). A geographic region in an around Seattle may have zero, one, or more viewing parties. Multiple geographic regions in and around Seattle may be grouped together and have only one venue hosting a single viewing party event or gathering across all of the given geographic regions of interest.

Based on the inputs to the computational model, at least one calculation will be determined to indicate whether zero, one, or multiple viewing parties may be auctioned off by the computational logic in any given designated geographic area. The Auction creation process may be automatic or manual. Venues must meet and sustain certain determined eligibility requirements to be allowed to bid in and win an open auction. Bidding for each auction by any eligible venues will be open for a certain period of time, and at the end of the certain time, one or more highest bidders in the auction will be the winner or winners of the auction. A venue that wins any given auction may gain certain rights to interact with spectators. Along these lines, business entities may use data produced by the computational model to make business and operational decisions. In some cases, one or more acts of the event-to-spectator prediction and hosting tool are recurring acts. The recurring nature of such processes permits the event-to-spectator prediction and hosting tool to accept new data associated with new spectators in the geographic region, new venues, and the like.

The third exemplary act in a process of the event-to-spectator prediction and hosting tool in the context of the professional football game example is considered. The third exemplary act considers the manual, automatic, or scheduled creation of auctions associated with professional football game in the present example.

In many cases, the creation of auctions includes determining the type of event or gathering that will be auctioned off (e.g., viewing party); creating a global auction using particular inputs; localizing the Auction; administering the auction so that venues can bid on events or gatherings. In addition, certain designated people or computing devices may be authorized to create, edit, delete, or otherwise interact with an auction. Various ones of the acts or portions thereof may recur.

In the present case the determined event type is a viewing party secondary event arranged around a professional football game primary event. Other types of events or gatherings and their associated data may include traditional events, tournaments, series, seasons, and one-time events. A traditional event or gathering occurs one time, at a specific time.

A tournament event or gathering is an event or gathering based on a sports game. Here, it may or may not be learned or known which team will advance in the tournament. A series is a collection of events based on a sports game, wherein the same teams may play against each other several times. Also here, a single auction may be arranged to host all events or gatherings in the collection, such as a 3-game baseball series. A season is a collection of events or gatherings based on a planned series, such as a season of a television show or a soccer team. One-time events include a single event (e.g., a professional basketball league draft, a State of the Union Address, a live televised musical, etc.).

Also in the third exemplary act, a process of the event-to-spectator prediction and hosting tool creates a global auction using previously provided inputs associated with the professional football game. The auction is scheduled and executed. The auction is also localized to each venue's location so that venue hosts can view auction details in a familiar time frame. Various attributes, minimum bids, different bidding increments, and other such functions are administered. Such actions may be automated.

Each auction is created using various weighted inputs and associated calculations as discussed herein. Each auction will operate and run as a multi-user system with determined functions. Inputs to the auction may include, but are not limited to, one or more locations of venues (e.g., the specific location of a venue or a number of venues within a given geographic region); a number of venues (e.g., a count of venues located within a given geographic region); placement of venues (e.g., a list of locations of all venues across a given geographic region of interest); and eligibility of venues (e.g., capacity, rating, age limits, and the like). Local data may also be provided, which can include a number of possible spectators in the geographic region, and a number of eligible venues that can win the auction in the geographic region. An automatically generated or manually written description of the auction may also be provided along with other data that influences bidding.

The fourth exemplary act in a process of the event-to-spectator prediction and hosting tool in the context of the professional football game example is considered. The fourth act is directed toward execution of bidding in an auction by one or more venues for an opportunity to host a viewing party (i.e., an event or gathering) in a given geographic region.

For each auction, details of the viewing party, including auction time and date data, geographic region, minimum bid, bid increment, and the like, are presented to a pool of prospective venues that may desire to host such a viewing party. The presentation to the pool of prospective venues may be made by direct contact, by public accessibility (e.g., via a web page), or by some other means. Venues are qualified to ascertain their eligibility to bid in the given auction, and if so qualified, a venue is permitted to bid in the auction. Eligibility criteria to bid in a given auction may include the venue's location, service size (e.g., maximum occupancy as determined by a regulatory authority such as a fire marshal), hours of operation, service offerings (e.g., food, liquor, number of private rooms, number and size of television-type displays, and the like). In some cases, eligibility criteria of a venue includes the venue entering payment authorization criteria and providing advance agreement to pay if the venue wins an auction. In some cases, some or all of the eligibility criteria of a venue may change from one auction to another auction.

In some cases, the event-to-spectator prediction and hosting tool presents an Internet-accessible, web-based “dashboard” that lists auctions, promotes or otherwise prioritizes various auctions, includes sorting tools (e.g., by category—e.g., sport, league, conference, division, team, channel, series, genre, and the like; by current bidding; e.g., only show auctions with other bids; by venue—e.g., only show auctions the venue has bid on). In some of these cases, the web-based dashboard may include other features as well. For example, unavailable auctions (e.g., auctions that are ended or otherwise closed, regions that do not have sufficient estimated expected attendance, and the like), and estimates of expected spectator attendance in a selectable regions of a selectable size.

Considering the professional football game example now under discussion, many spectators in and around Seattle are likely to attend a viewing party. Various estimates of the number of likely spectators in and around Seattle can be determined across a plurality of regions. For example, the number of spectators each of several single postal code regions can be estimated, and the number of spectators in groups of adjacent or nearby postal codes can also be estimated. Along these lines, the number of spectators in the entire City of Seattle or any sub-group thereof can be determined. By analyzing the various ways of parsing the geographic region in an around Seattle, the event-to-spectator prediction and hosting tool will select how many auctions will be held, and what the relevant details are for each auction (e.g., geographic location, pricing, open and close dates of the auction, and the like).

After an auction is opened, venues can bid, increase a bid, enter a maximum bid, which is higher than a current bid, such that the venue's current bid is automatically incremented as other competing venues bid, up to the maximum bid of the venue. After an auction ends, the winning venue pays or authorizes payment for the auction, and the event-to-spectator prediction and hosting tool provides support to the auction-winning venue to host the given event or gathering, which in the present example is a viewing party for the championship football game.

The fifth exemplary act in a process of the event-to-spectator prediction and hosting tool in the context of the professional football game example is considered. The fifth act regards payment for an auction that a venue has won. In some cases, the event-to-spectator prediction and hosting tool has implemented a “credits” system. In these embodiments, a venue may pay for an auction using credits, using another accepted form of payment (e.g., credit card, bank transfer, purchase order, and the like), or using a combination of credits and another accepted form of payment. In some cases, the event-to-spectator prediction and hosting tool is implemented such that credits associated with a venue are always used prior to paying for an auction using another accepted form of payment.

In some cases where payment fails, the underlying auction may be re-opened. In some cases where payment fails multiple times, the associated venue may be prohibited from bidding in subsequent auctions.

The sixth exemplary act in a process of the event-to-spectator prediction and hosting tool in the context of the professional football game example is considered. The sixth exemplary act is associated with follow-up by the event-to-spectator prediction and hosting tool after an auction closes. In some of these cases, the event-to-spectator prediction and hosting tool will publish details related to the underlying event or gathering (i.e., the viewing party), push such details via any number of websites, email lists, social media tools, and the like. In some cases, the event-to-spectator prediction and hosting tool will provide additional support leading up to, and continuing through, the event or gathering of interest.

In some cases, the concepts described herein to generate an estimate of expected attendance at a given event or gathering may be used for still other different or additional purposes. For example, an estimate of expected attendance at a given event or gathering may be used to facilitate an event-to-spectator connection tool. One embodiment of such a tool can apply an estimate of expected attendance at a given event or gathering to improve a conventional social network by connecting participants in the social network that have a common interest (e.g., fans that root for a particular sports team) at a selected venue (e.g., a sports bar that is broadcasting a competition featuring the particular sports team). In these or in alternative cases, the conventional social network infrastructure itself is improved or even displaced because rather than encouraging human relationships through an electronic proxy (i.e., via a computing device), any number of participants having any number of different common interests can be directed, informed, or otherwise encouraged to engage in direct human-to-human relationships at an event or gathering without the need for a computing device proxy (e.g., a smartphone, tablet, and the like).

The features now disclosed form a new type of network that may act as a social network or supplement an existing social network. The network implements a highly automated computational model that is also highly scalable. People who participate in the network benefit from the increased, emotionally rewarding human contact. And by encouraging and enabling an efficient means of bringing people with common interests together at a venue, the essence of conventional, distributed computing social networks are improved.

Many spectators of sporting events, political events, trivia night events, television show watch-party events, and many other types of events are also members of one or more social networks. When a spectator (e.g., a fan) identifies an interest in a particular activity, and when the spectator associates himself or herself with a particular location (e.g., an established location, a current location, a future location), the social network can identify and classify the spectators based on their common interest in one or more activities and based on their common association with a particular geographic region.

Along these lines, venues may also participate in social network activities. Many venues use social networks to advertise the goods and services sold by the venue.

It has been discovered that when an event-to-spectator connection tool is employed as described herein, spectators will engage with the event-to-spectator connection tool in order to facilitate human-to-human interaction with others that share a common interest and that are located in a same or nearby geographic region. In addition, it has been further discovered that venues will engage with the event-to-spectator connection tool in order to gain access to certain spectators located in the same geographic region as the venue, the certain spectators sharing a common interest. And it has also been discovered that venues may, in some cases, pay for access to the certain spectators, host events associated with the common interest, and sometimes provide incentives to encourage the certain spectators to gather at the venue for a hosted event.

In some embodiments, the event-to-spectator connection tool forms a network that is accessible through the Internet on a wide variety of computing devices. The computing devices may include, but are not limited to, desktop computers, distributed computing devices, laptop computers, tablets, smartphones, wearable computing devices, vehicle-based computers, Internet of Things (IoT) devices, and any other Internet-enabled computing device. In some cases, the event-to-spectator connection tool interactively serves pages of a website, which may or may not include multimedia content, tactile content, and other types of human sensory content.

In some embodiments, users sign up or otherwise register with the event-to-spectator connection tool. At least two types of user accounts are enabled by the event-to-spectator connection tool. A first type of account is directed toward spectators that specify their common interests, location information and, in some cases, other data. A second type of account is directed toward venues. Venues will provide service location information (e.g., a street address of the venue), demographic-type information regarding their service offerings and, in some cases, other data.

In one or more embodiments, venues engage in paid and unpaid activities on the network. Venues may bid on (e.g., in an auction), purchase, win, or otherwise acquire the right to engage with spectators who have accounts on the network and other people who may also share both a common interest with certain members, and are associated with a same or nearby geographic region as the certain members.

The right to engage with certain spectators acquired by a certain venue provides beneficial marketing and promotional opportunities to the venue. For example, a venue may acquire the right to host an event or gathering that is promoted by the network. A venue may also acquire the right to directly market goods and services to spectators having a known common interest. In many cases, the rights acquired by the venue can be exploited by the venue to generated initial revenue and recurring revenue.

In order to realize these benefits, a network implemented by the event-to-spectator connection tool automates particular sales, marketing, execution, and follow-up tasks; each of which is discussed in detail in the present disclosure.

Within a sales task, network groups are created, network groups and associated events or gatherings are matched to venues, sales of access to network spectators are made and confirmed, one or more events or gatherings are organized with event partners, and details regarding the events or gatherings are published. In cooperation with the sales task, various sub-tasks within a marketing task include initiating an event or gathering and updating it when necessary, further promoting the event or gathering via available channels, and shepherding the pre-event or pre-gathering tasks amongst all parties. Upon completion of the sales and marketing tasks, and when the appointed day and time arrive, the event or gathering is administered. Administration of the event includes setup, execution, and cleanup. After the event or gathering completes, a follow-up task draws information from relevant network groups, the event host, and any involved event partners, and a post-mortem task captures repeatable data associated with the now-concluded event or gathering, and this data may be shared with network group representatives.

Considering sales tasks in more detail, embodiments of an event-to-spectator connection tool include logic arranged to receive sales-related inputs and logic arranged to provide sales-related outputs. In some cases, the logic that receives particular inputs is arranged to receive data automatically (e.g., from a third-party service provider that feeds sports event details, details of community-wide social activities, and the like). In these or other cases, data is provided manually such as through a website, for example. Input data to the logic arranged to receive sales-related inputs includes network group inputs (e.g., location, size, privacy, discounts, etc.), event host inputs (e.g., amenities, location, size, discounts offered, etc.), and event or gathering inputs (e.g., location, teams, day/time, rivalry or other multipliers, etc.). Data that is output to the logic arranged to provide sales-related outputs includes network group outputs, additional data from spectators, revenue data, network information (e.g., web, mobile web, mobile app, etc.), low- or no-cost additions to the event or gathering, and additional promotional opportunities/channels outputs.

Using the input information and the output information, the event-to-spectator connection tool is arranged to identify a network group or an interested party. The interested party is, for example, a real person or a digital persona (e.g., an “avatar”) who may be interested in attending an event or gathering based on a certain common interest. The event-to-spectator connection tool is also arranged to identify a venue and corresponding event host in a particular geographic area and at least one event or gathering where the identified network group or interested party is encouraged to gather.

The creation of network groups in the event-to-spectator connection tool may be implemented as a distinct logic module having three distinct sub-parts. In some embodiments, a first sub-part includes identifying existing network groups, a second sub-part includes creating new network groups, and a third sub-part includes supplementing an event-to-spectator connection tool with network group information.

The distinct logic module used to create the network groups in some embodiments of the event-to-spectator connection tool may take particular inputs and provide particular outputs. In some cases, input data is automatically pulled from a data feed, and in these or other cases, data is manually entered. Exemplary but non-limiting data passed into the logic module used to create the network groups may include regional data from mapping databases or other sources, data from streaming services such as a sports data aggregator, spectator data from one or more internal or otherwise associated databases, or the like. In these and in other cases, input data is drawn from existing network groups such as social network groups, alumni associations, online meetup service providers, formal fan groups, and other such network groups. In some cases, output data includes the particular groups, new data from spectators, increased data from spectators, and the like.

Considering the distinct logic module used to create the network groups in some embodiments of the event-to-spectator connection tool, a first sub-part includes identifying existing network groups. Existing network groups may be identified or otherwise discovered by using web-crawlers that scrape Internet data, by engaging directly with existing network group administrators (e.g., phone calls, electronic mail, and the like), by using purchased or shared electronic mail lists, and in other ways. Working cooperatively with pre-existing network groups is often mutually beneficial because such cooperative efforts help grow the organizations of both sides in ways that increase user engagement. Information drawn from existing network groups, which may include individual user information, is saved in one or more event-to-spectator connection tool databases

A second sub-part of the distinct logic module creates new network groups in some embodiments of the event-to-spectator connection tool and a third sub-part supplements the event-to-spectator connection tool with network group information. Creating new network groups includes building new online communities having a common interest through social media. As individual spectators are classified into any particular network group, relevant administrative information of the network group is entered or otherwise updated. Such administrative information includes, for example, network group size, network group common interest designator, and geographic region. Supplementing the event-to-spectator connection tool with network group information may include identifying and engaging a human or digital leader of the network group lead (e.g., a captain) to help organize network group efforts and communication at the local level. In these or other cases, each spectator creates their own network profile, and each new profile adds data to the event-to-spectator connection tool. It has been learned that many members having a common interest (e.g., being a fan) in one activity will also have other common interests in other activities (e.g., teams, sports, television series, or the like).

As just described, the creation of network groups in the event-to-spectator connection tool may be implemented by leveraging various lead-generation methods and by identifying interested parties having a particular common interest in a defined geographic area. Examples include the formation of cooperative network relationships with sports team, television show stakeholders, political parties, colleges and universities, video game creators and administrators, and the like.

The matching of network groups and associated events or gatherings to venues in the event-to-spectator connection tool may be implemented as a distinct logic module having two distinct sub-parts. In some embodiments, a first sub-part includes determining pricing for each type of access that a venue receives to the network, and a second sub-part includes determining the type of sales made to a particular venue. In some cases, details related to pricing for each individual type of access that a venue receives to the network may be classified within the event-to-spectator connection tool as separate stock keeping units (i.e., SKUs).

The distinct logic module used to match the network groups to venues in some embodiments of the event-to-spectator connection tool may take particular inputs and provide particular outputs. In some cases, input data includes relevant details of the network group of interest, relevant details of the venue of interest and an event host associated with the venue of interest, and relevant details of one or more events or gatherings of interest. In some cases, output data includes relevant pricing details for individual types of access that a venue receives to the network (i.e., SKUs).

Considering the distinct logic module used to match the network groups to venues in some embodiments of the event-to-spectator connection tool, a first sub-part includes determining pricing for each type of access that a venue receives to the network. In some embodiments, pricing for access to the network is flat rate pricing, in some other embodiments pricing follows a subscription model, and in some embodiments, pricing includes a down-payment and a per-spectator check-in charge.

Flat rate pricing for access to the network may include a one-time price based on a percentage of expected revenue generated when the venue is granted access to the network for one or more particular events or gatherings (e.g., game, season, tournament, series length (i.e., television, political debates, and the like), a custom event or gathering (e.g., a draft, an exhibition, a pre-game party, and the like), or some other event or gathering). Subscription model pricing for access to the network may include charging a venue or an associated event host a recurring amount of money based on a number of events, gatherings, promotional activities, or other services are provided over a given time period. In these cases, for example, a particular venue or event host may be promoted as an official venue or event host for all events or gatherings associated with a given team, all events or gatherings associated with episodes of a television season, all events or gatherings associated with one or more debates for a given political party, and the like. Alternatively, or in addition, a particular venue or event host may be provided with an agreed-upon number of events or gatherings during a given time period, regardless of the underlying common interest. Pricing for a down-payment and a per-spectator check-in model may involve charging a venue or event host a set initial fee or a down payment based on a percentage of expected revenue generated via access to the network group. In some of these cases, the expected revenue may include revenue covering one or more events or gatherings (e.g., single game, single episode, single political event, entire season, entire series, tournament, or custom event). Such pricing is based on agreed-upon terms. Additionally, in pricing that follows the down-payment and a per-spectator check-in model, the venue or event host is secondarily charged after each event or gathering an amount based on the number of spectators who checked into the event or gathering using, for example, a mobile application or web-based interface communicatively coupled to the event-to-spectator connection tool.

A second sub-part of the distinct logic module includes determining the type of sales made to a particular venue. One type of sale is a manual, direct sale made to a venue or associated event host. In these cases, terms of the sale are based on one-to-one communications with the venue or associated event host. Another type of sale includes an automated auction type sale. In these auction cases, terms of a sale are based on a final auction price produced in an event-to-spectator connection tool or in an event-to-spectator prediction and hosting tool. Here, pricing is determined when a plurality of venues or associated event hosts determine a final auction price after one or more rounds of competitive bidding for the right to host one or more events or gatherings.

Recognizing that some venues or event hosts will have different preferences on the type of sale, some embodiments of an event-to-spectator connection tool collect and store information associated with a venue's or event host's level of risk aversion, confidence in the network group, and the like. In these cases, pricing models may be created by computationally combining the stored risk aversion and confidence information.

The sale of access to network spectators, and the confirmation of such sales, in the event-to-spectator connection tool may be implemented as a distinct logic module having four distinct sub-parts. In some embodiments, a first sub-part includes developing price and payment structures, a second sub-part includes communications with qualified venues or associated event hosts, a third sub-part includes confirming a sale with an individual venue or associated event host, and a fourth sub-part includes collecting payment.

The distinct logic module used to administer sales of access to network spectators, and the confirmation of such sales in some embodiments of the event-to-spectator connection tool may take particular inputs and provide particular outputs. In some cases, the input data includes payment information such that each venue and each associated event host has its own associated secure profile in the event-to-spectator connection tool. The secure profile is arranged to store payment information used to collect payment. Input data may also include agreed upon pricing and pricing model information (e.g., flat rate, subscription model, down payment plus per-spectator check-in). And input data may also include chronologic information (e.g., date of sale, date of one-time charge, date or dates of post-event or post-gathering charges based on check-ins) and new vs. existing customer information. New customer input information permits a new venue or event host to create a profile or take over an existing profile of that host itself that was created by the event-to-spectator connection tool. For example, in some cases, the event-to-spectator connection tool creates a network group to classify existing spectators based on a common interest (e.g., fans of a particular team in a particular city), and later, a third-party better situated to administer the network group is permitted to take over the network group. In these cases, venues or event hosts can enter relevant payment information, billing addresses, and the like.

In some cases, output data from the distinct logic module used to administer sales of access to network spectators includes revenue, scheduled events or gatherings, and the like.

Considering the distinct logic module used to administer sales of access to network spectators, and the confirmation of such sales in some embodiments of the event-to-spectator connection tool, a first sub-part includes developing price and payment structures. The first sub-part may also include developing and administering specific lists of targeted venues and associated event hosts. A second sub-part includes communicating with qualified venues or associated event hosts. Detailed proposals may be sent to specific venues or event hosts in a given geographic region, and interested hosts and venues may be qualified based on sufficient matching of relevant network group data to relevant venue or associated event host data.

A third sub-part includes confirming a sale with an individual venue or associated event host. In these cases, contract terms may be automatically generated and electronically approved within the event-to-spectator connection tool, the contract terms may be electronically communicated to the venue or associated event host for authorization, an authorized set of contract terms may be electronically received, and the contract terms may be securely stored in an event-to-spectator connection tool database. Also in the third sub-part, any promotions offered by the venue or event host for the network group may be confirmed.

A fourth sub-part is arranged to administer payment collection. The fourth sub-part may be communicatively coupled to payment information of the venue or associated event host profile, and can include receiving payment via a third-party payment processing entity. In these cases, the payment information may be flat rate (e.g., one-time, up-front) payments, subscription model payments via periodic invoice for agreed-upon services, down payment plus per-spectator check-in payments, or some other payment mechanisms.

The organization of one or more events or gatherings with event partners in the event-to-spectator connection tool may be implemented as a distinct logic module having four distinct sub-parts. In some embodiments, a first sub-part includes administration of sales of access to network spectators, and the confirmation of such sales; a second sub-part includes manually directed and automatic electronic communications with potential event partners; a third sub-part includes qualification of partners based on network group, event host, and event or gathering details; and a fourth sub-part includes a confirmation of the level of involvement from qualified event partners.

The distinct logic module used to organization of one or more events or gatherings with event partners in some embodiments of the event-to-spectator connection tool may take particular inputs and provide particular outputs. In some cases, input data includes certain network group details such as specifically requested information from the network group for their assigned events or gatherings. Other input information includes event partner details. The event partner information may include, but is not limited to, industry information such as beverage, food, apparel, non-profit, media, etc.; location information; goods, services, or goods and services being offered information; and event host availability during a designated event or gathering information. Additional input information includes venue or associated event host details such as physical limitations, pre-existing partner relationships, promotions used in the past, and other such information. Still other input information includes event or gathering details, location, teams, day/time, rivalry or other multipliers, and a level of involvement from an event partner, event host, co-host, sponsor, affiliate, and the like. Output information may include, but is not limited to, no-cost additions to the event or gathering, additional promotional opportunities made available through partner channels, and the like.

The publishing of details regarding the events or gatherings in the event-to-spectator connection tool may be implemented as a distinct logic module having four distinct sub-parts. In some embodiments, a first sub-part includes electronic confirmation that event host information is correctly presented on web pages or display screens served by a user interface of the event-to-spectator connection tool. Here, accuracy of the name of the event host is confirmed, the correctly associated multimedia is confirmed, location information is confirmed, and contact information is confirmed. A second sub-part includes electronic confirmation that event or gathering information is correctly presented on web pages or display screens served by a user interface of the event-to-spectator connection tool (e.g., accuracy of teams, location, time, and the like). A third sub-part includes electronic confirmation that promotions are displayed, and a fourth sub-part includes electronic confirmation that any customized descriptions are accurate.

The distinct logic module used to publish details regarding the events or gatherings in the event-to-spectator connection tool may take particular inputs and provide particular outputs. The input data is associated with the particular event or gathering and in some cases includes event or gathering details (e.g., teams, series, or other common interest involved, location, time, etc.), event host details, promotion details, and event partner details if there are any. Output information includes electronic presentation of the event or gathering of interest on web pages or display screens served by a user interface of the event-to-spectator connection tool.

As mentioned herein, embodiments of an event-to-spectator connection tool provide many benefits. In order to realize these benefits, a network implemented by the event-to-spectator connection tool automates particular sales, marketing, execution, and follow-up tasks. A sales task has previously been discussed in detail in the present disclosure. A marketing task is now described in detail.

In cooperation with the marketing task, various sub-tasks within a marketing task include initiating an event or gathering and updating it when necessary, further promoting the event or gathering via available channels, and shepherding the pre-event or pre-gathering tasks amongst all stakeholders. Via marketing tasks, the event-to-spectator connection tool matches spectators having a common interest with each other and incentivizes them to attend events and gatherings hosted at determined venues by event hosts, thereby providing the venue and event host with new customers and revenue.

Considering marketing tasks in more detail, embodiments of an event-to-spectator connection tool include logic arranged to receive marketing-related inputs and logic arranged to provide marketing-related outputs. In some cases, the logic that receives particular inputs may be arranged to receive data automatically. In these or other cases, data may also be provided manually such as by input into a website, for example. Input data to the logic arranged to receive marketing-related inputs includes organic data, influencer-data, promotions-data, endorsements, third-party press, contracted press, and the like.

Data that is output to the logic arranged to provide marketing-related outputs includes current and accurate information related to various aspects of the event or gathering. In some cases, such output data is also pushed through additional promotional channels. Benefits from such output and promotion of the event or gathering of interest to relevant spectators having a common interest and geographic location include increased visibility and awareness of specified events and gatherings, increased brand recognition, increased attendance at the event or gathering, and increased revenue generated from event or gathering.

Marketing information related to an event or gathering is updated based on changes associated with a network group, event host, event partner, underlying activity, or some other relevant factor. Updating an event or gathering in the event-to-spectator connection tool may be implemented as a distinct logic module having one or more distinct sub-parts. In some embodiments, the one or more distinct sub-parts include staying in electronic communication with all stakeholders leading up to the event or gathering, adjusting event or gathering details as needed based on updated information, and verifying event or gathering details prior to execution of the event or gathering.

The distinct logic module used to update an event or gathering in some embodiments of the event-to-spectator connection tool, may take particular inputs and provide particular outputs. In some cases, input data includes any one or more of network group details, event host details, event partner details, and other details regarding the activity underlying the event or gathering. In some cases, output data includes current accurate information related to any aspect of the event or gathering.

The publication of the event or gathering via available channels in the event-to-spectator connection tool may be implemented as a distinct logic module having several distinct sub-parts that present event and gathering information on as many relevant third-party platforms as achievable. In some embodiments, the sub-parts include electronically communicating with certain third-party social networks, electronically communicating relevant event or gathering details to interested and available non-social-network third-party platforms, and electronically verifying that relevant details associated with the event or gathering display accurately on third-party platform.

The distinct logic module used to publish the event or gathering via available channels in the event-to-spectator connection tool may take particular inputs and provide particular outputs. In some cases, input data includes event or gathering details captured from a third-party platform, information from new and existing event partners, and multimedia and traditional print promotional material. The input information may be local, national, or global, and the input information may be directed to a single point in time or input in an ongoing basis. In some cases, output data includes additional promotional channels and other such information that will increase the visibility and awareness of a specific event or gathering, increase brand recognition, and provide other marketing benefits.

The further promoting of the event or gathering via available channels in the event-to-spectator connection tool may be implemented as a distinct logic module having several distinct sub-parts that leverage various promotional channels to drive awareness of the event or gathering. In some embodiments, the sub-parts include identification of applicable promotional channels (e.g., national vs. local; private vs. public; team affiliated vs. team agnostic), provision of relevant event or gathering data to various channels, verifying accuracy and display of promotional material according to specifications, and promotion of all third-party channels through various event-to-spectator connection tool channels.

The distinct logic module used to further promote the event or gathering via available channels in the event-to-spectator connection tool in some embodiments of the event-to-spectator connection tool may take particular inputs and provide particular outputs. In some cases, input data includes any relevant event or gathering information that is available to or from any particular promotional channels. The particular promotional channels may include web, mobile, email, social media, and the like, associated with network groups, event hosts, third-party platforms, influencers, digital advertising, and media/press. Media/press may include information from local media outlets, press releases, and the like. Influencers may include celebrities, athletes, and the like. In some cases, input information is sourced from digital advertising that is targeting ads to a specific audience.

In some cases, output data associated with an event or gathering includes third-party social network marketing and search engine marketing that provides increased visibility and awareness of specified events and gatherings, increased brand recognition, and other benefits.

Communication in the event-to-spectator connection tool may be implemented as a distinct logic module having distinct sub-parts. In some embodiments, the distinct sub-parts may include identification of an acceptably efficient way to communicate with various stakeholders (e.g., telephone, email, text message, and the like), specification of a frequency with which to communicate with various stakeholders (e.g., daily, weekly, quarterly, etc.), and communication via agreed-upon methods as desired.

The distinct logic module used to enable communication in some embodiments of the event-to-spectator connection tool may take particular inputs and provide particular outputs. In some cases, input data is network group details, event host details, event partner details, and promotional channel details. In some cases, output data represents increased attendance at the event or gathering and verifiably increased revenue generated from the event or gathering. Some benefits of such output include increased brand trust, predictable attendance to optimize staffing, additional transparency, and promotion of successful events or gatherings.

As mentioned herein, embodiments of an event-to-spectator connection tool provide many benefits. In order to realize these benefits, a network implemented by the event-to-spectator connection tool automates particular sales, marketing, execution, and follow-up tasks. Sales tasks and marketing tasks have previously been discussed in detail in the present disclosure. An execution task is now described in detail.

Upon completion of the sales and marketing tasks, and when the appointed day and time arrive, the event or gathering is administered. Administration of the event includes setup, execution, and cleanup.

Execution of the event or gathering is arranged to increase attendance and revenue. Well-organized events or gatherings with few gaps in delivery and execution produce satisfied stakeholders including event hosts, network groups, event partners, spectators, and others. Such well-organized events or gatherings lead to increased spectator engagement throughout the event or gathering, increased registration in the event-to-spectator connection tool, increased revenue based on number of check-ins, and re-usable multimedia content.

Setup of an event or gathering is substantially a physical process that is guided by the event-to-spectator connection tool to verify that all items for the event or gathering are in place prior to commencement of the event or gathering. During setup, spectators may be taught about direct access via the Internet or a mobile application to the event-to-spectator connection tool, event partners are engaged, and any event extras offered. Such guidance may be implemented as a distinct logic module having distinct sub-parts. In some embodiments, a first sub-part includes automatic electronic verification that a feature that delivers event and gathering promotions only after a spectator uses the check-in feature of the event-to-spectator connection tool is displaying properly. In this sub-part, web, mobile web, mobile application, and other electronic data delivery means are verified. In a second sub-part, electronic communications are established with an event host, event and gathering details are electronically confirmed, education of event host staff is verified, a designated area for network group gathering within the venue is verified, and set up of any event partner/sponsor signage, raffle prizes, and other promotional materials are verified. In a third sub-part, electronic contact is made with an administrator of the network group and event or gathering details are confirmed, including promotions and activities. In a fourth sub-part, electronic contact is made with event partners to confirm detailed involvement and expectations; and in a fifth sub-part, current execution of the event is promoted on social media. In this sub-part, all involved parties may be “tagged” as network groups, event hosts, event partners, or the like.

The distinct logic module used to electronically verify that all items for the event or gathering are in place prior to commencement of the event or gathering in some embodiments of the event-to-spectator connection tool may take particular inputs and provide particular outputs. In some cases, input data includes event or gathering details, event host details, network group details, event partner details, and the like. In some cases, output data includes verification of attendance, multimedia, and the like.

Execution of an event or gathering is substantially a physical process that is guided by the event-to-spectator connection tool to verify that all items for the event or gathering are in place during execution of the event or gathering.

To manage execution, certain portions of the event-to-spectator connection tool may be implemented as distinct sub-parts of a distinct logic module. In some embodiments, a first sub-part verifies, during execution, that event hosts or others make announcements to encourage other spectators to join the network via electronic access through the event-to-spectator connection tool. Announcements are made before and during the event or gathering, and again during key points of the event or gathering activity (e.g., halftime, end of game, etc.). Gratitude is shared with spectators and shareholders, and certain network operations and benefits are explained to spectators. In a second sub-part, electronic interaction with a network group administrator, event host, event partners, and the like is verified. Spectators attending the event or gathering may be walked through a sign-up/registration process. Delivery of promotional material freely or through onsite activities may also be verified. And in a third sub-part, other on-site activities can be verified such as raffles, smaller prize giveaways during the event, or gathering and grand prize giveaway at the end of the event or gathering. Multimedia can be captured (e.g., pictures, videos, and the like). In some cases, interactions between stakeholders (e.g., network group, event host, and event partners) is also verified, and various promotion is made on social media via comments, tagging, posting of multimedia.

Cleanup of an event or gathering is substantially a physical process guided by the event-to-spectator connection tool to verify that all items for the event or gathering are cleaned up after execution of the event or gathering.

To manage cleanup, certain portions of the event-to-spectator connection tool may be implemented as distinct sub-parts of a distinct logic module. In some embodiments, the sub-parts include verification of taking down all promotional materials/signage provided by the network, the network group, and/or event partners, verification of re-gathering left-over promotional gear, raffle prizes, and event partner giveaway items, and optionally closing out any open tabs and collecting receipts.

As mentioned herein, embodiments of an event-to-spectator connection tool provide many benefits. In order to realize these benefits, a network implemented by the event-to-spectator connection tool automates particular sales, marketing, execution, and follow-up tasks. Sales tasks, marketing tasks, and execution tasks have previously been discussed in detail in the present disclosure. A follow-up task is now described in detail.

After completion of the sales and marketing tasks, and after conclusion of the event or gathering, a post-mortem task can be conducted. Feedback from the post-mortem is used to improve operations of the event-to-spectator connection tool. Feedback information is electronically collected from any one or more of the network group, venue, event host, event partners, and others. Information may be electronically determined to be qualitative, quantitative, or both. The information may include case studies, testimonials, and other impressionistic information directed toward venues, event hosts, network groups, event partners, and others. Based on an electronic review system, future events or gatherings associated with the network group, event host, event partner, and others may be determined, encouraged, or discouraged. Based on the post-mortem, changes can be made to attempt an improvement in attendance, an increase in revenue, and to achieve other benefits.

A post-mortem engagement of the network group conducted by the event-to-spectator connection tool may be implemented as a distinct logic module having distinct sub-parts. In some embodiments, one or more of the sub-parts includes gathering feedback from a network group lead regarding treatment of staff, gathering feedback regarding any challenges faced with the network platform (e.g., check-in-to-receive-promotional-gifts feature), automatically retrieving or otherwise reviewing multimedia, comments, or other information posted on social media, requesting text-based or multimedia testimonial, and the like. In some cases, future event or gathering planning begins during the post-mortem operations.

A post-mortem engagement of the network host conducted by the event-to-spectator connection tool may be implemented as a distinct logic module having distinct sub-parts. In some embodiments, one or more of the sub-parts includes gathering feedback from the event host. The event host may provide a candid overall impression of the event or gathering, which is recorded by the event-to-spectator connection tool. In some cases, the candid impressions include an assessment of behavior of the network group (e.g., respectful, noisy, etc.), an assessment of challenges faced with the network platform (e.g., a check-in-to-receive-promotional-gifts feature), and a request for a testimonial about a successful event or gathering. In these or other embodiments, objective data regarding the event or gathering may be collected, such as the number of spectators that checked into the event or gathering via a mobile device, an Internet-enabled device, or the like. Based on receiving such objective feedback, a venue or an associated event host may be automatically charged any remaining balance. In some cases, actual attendance is compared to estimated attendance, and the comparison data is used to guide charges, future proposals, and other aspects of a future event or gathering.

Along the lines of engagement with network groups and event hosts, a post-mortem engagement of event partners may also be conducted by the event-to-spectator connection tool. Such an engagement may be implemented as a distinct logic module having distinct sub-parts. In some embodiments, one or more of the sub-parts includes gathering feedback from the event partner, which may include candid overall impressions of the event or gathering that are recorded by the event-to-spectator connection tool. In some cases, the candid impressions include an assessment of behavior of the network group (e.g., respectful, noisy, etc.) and performance of the event host. The data, which may be qualitative, quantitative, or both qualitative and quantitative may be captured numerically and used by the event-to-spectator connection tool to score venues, event hosts, network groups, and others. Such scores may be used in the calculation of pricing or award of rights to access certain network spectators.

Using the collected post-mortem data, the event-to-spectator connection tool can provide an additional stream of data to be used in estimates of attendance at particular events or gatherings.

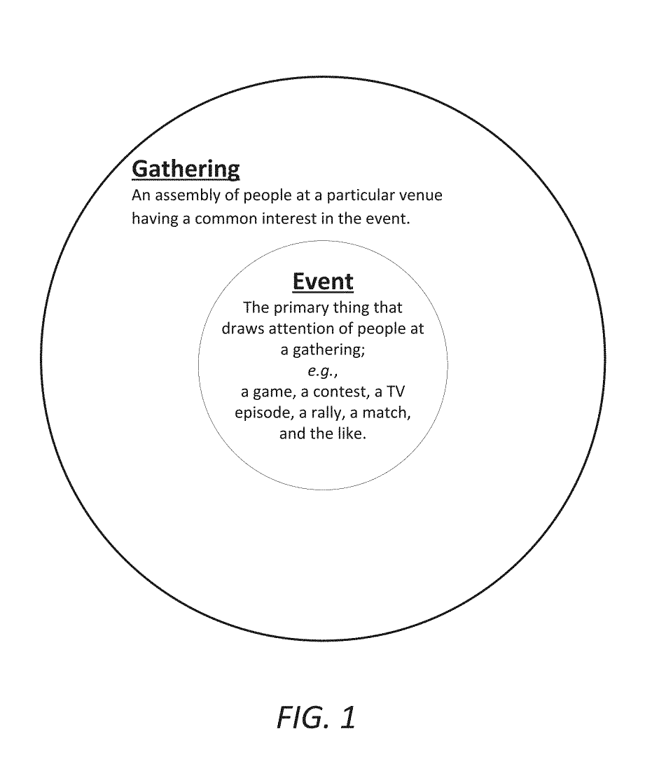

FIG. 1 shows the relationship between a gathering and an event, as the terms are used in the present disclosure. As discussed herein, an event includes any live (in-person) broadcast or recorded activity that is supported, promoted, conducted, or otherwise directed by an entity. An event is a primary person, place, or thing that draws attention. Events include sports contests, games, matches, sets, races, and any other like competitions. For example, events include soccer games, football games, hockey games, baseball games, tennis matches, cricket matches, bowling sets, card games, video games, games of chance, games of skill, and any other such event where participants compete. Events may include any one or more of human beings, animals, and machines. Events may include individual competitors, teams, and teams of individual competitors. Events may be played or fought, competitive or collaborative, or something entirely different. For example, events may include instruction such as surgery, construction, the creation of art, or another human or non-human endeavor. In other cases, events may include movies, episodes of a television or other like “show,” concerts, and the like. Events may be conducted in a single locale such as a tennis match or a chess match. In addition, or in the alternative, events may be distributed geographically such as a rocket launched into space. Events may be live, recorded, or both live and recorded, and spectators may view a live or recorded event in person or via an electronic means such as a computing device, a television, a radio, or the like. In one broad sense, an event is a person, place, thing, or happening that humans are interested in viewing.

A gathering, as the term is used herein, is an assembly of people coming together at a particular venue to view an event. The assembly may be live and in person, such as when people travel to a place of public accommodation such as a bar, restaurant, stadium, or the like. The gathering may also include people coming together at a personal residence or via an electronic means such as via the Internet, via a fee-for-service (e.g., pay-per-view), or by some other means.

In FIG. 1, a primary event occurs in a central, inner circle, and a gathering, which may be referred to as a secondary event, draws the attention of an assembly of people at a particular venue in the outer circle. The shapes, sizes, and other characteristics of FIG. 1 are not limiting. For example, in some cases, the number of participants in an event is substantially smaller than the number of participants in a gathering. A magic show, for example, may have a single participant in the event (i.e., the magician) while a live gathering may include hundreds of people (i.e., an audience in an auditorium watching the magic show) and a remote gathering may include tens, hundreds, or thousands of people gathered in another venue to watch an electronic broadcast of the magic show.

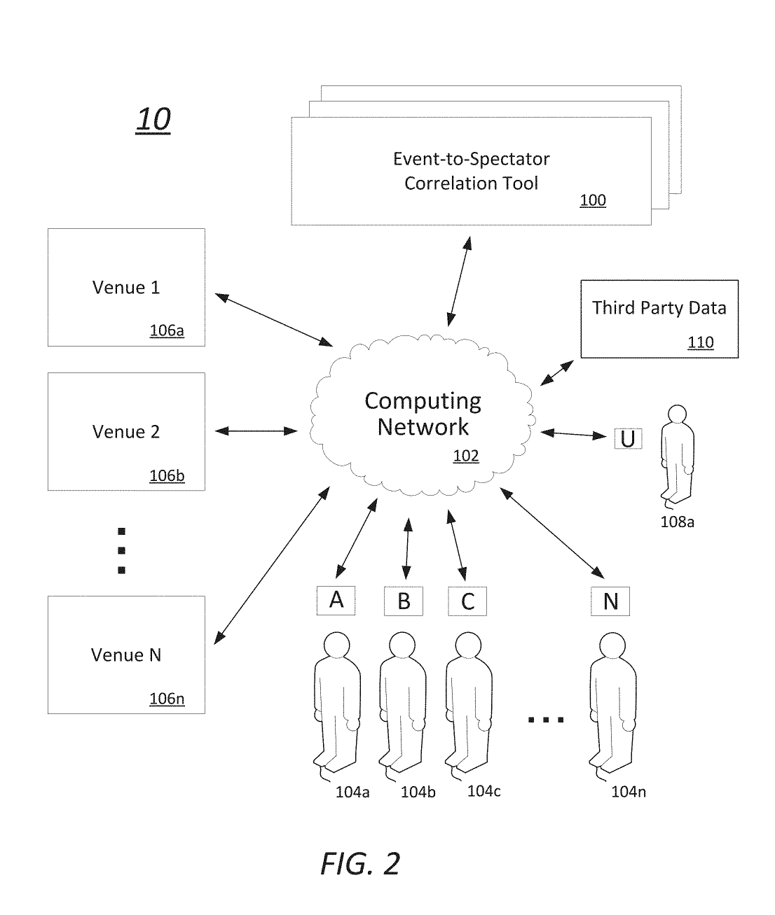

FIG. 2 is a system 10 that implements an event-to-spectator correlation tool embodiment. In the system 10 of FIG. 2, an event-to-spectator correlation tool 100 is communicatively coupled through a computing network 102 to a plurality of spectators 104a-104n. Each spectator 104a-104n is associated with at least one computing device, which are illustratively represented in FIG. 2 as A, B, C, and N. The event-to-spectator correlation tool 100 is also communicatively coupled through the computing network 102 to one or more venues 106a-106n, at least one event-to-spectator correlation tool user 108a, and to at least one third-party data source 110.

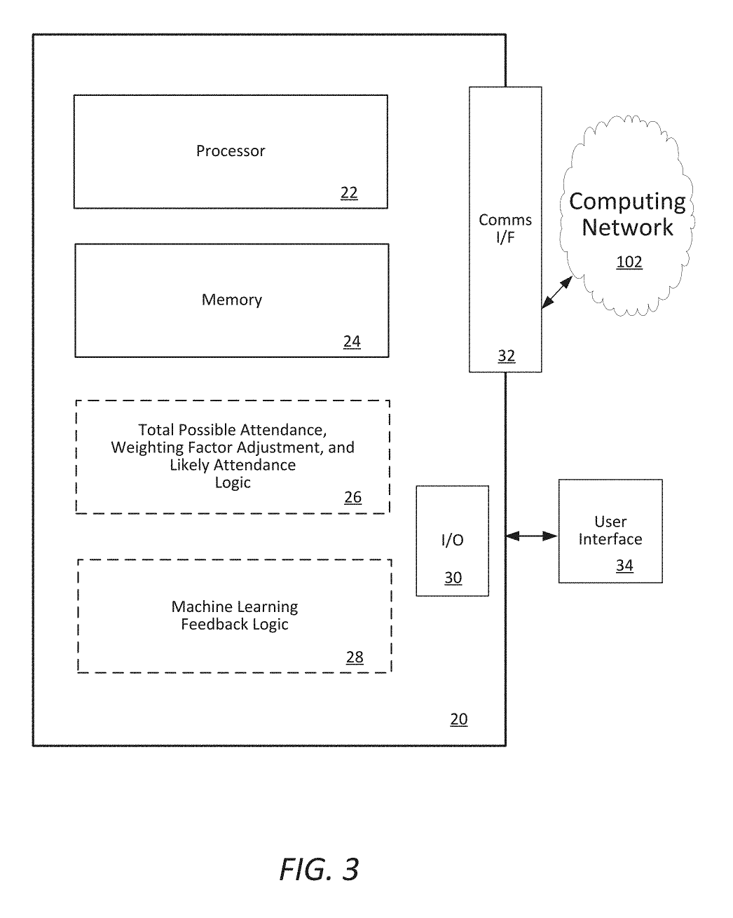

The event-to-spectator correlation tool 100 is or otherwise includes a computing server, which is a computing device 20 (FIG. 3) arranged for particular networked computing operations. The computing server, when so arranged with particular software logic, hardware logic, or a combination of software and hardware logic is transformed from a generic and unspecific general purpose computing device to a specialized combination device comprising hardware and software configured for a specific and particular purpose.

The spectator computing devices in FIG. 2, identified as A, B, C, and N, are also computing device 20 (FIG. 3) arranged for communication with an event-to-spectator correlation tool 100. The spectator computing devices A, B, C, and N may be any one or more of desktop computers, laptop computers, tablets, smartphones, wearable computing devices, automotive or other vehicle embedded computing devices, or any other type of fixed or mobile computing device.

Each of venues 106a-106n may also include an associated computing device 20 (FIG. 3). And the one or more event-to-spectator correlation tool users 108a, along with the at least one third-party data source 110, are also arranged as computing devices 20 (FIG. 3). The computing device of the event-to-spectator correlation tool users 108a is identified as U.

Network 102 may be or otherwise include one or more of a wide area network (WAN) such as the Internet, a local area network (LAN), a personal area network (PAN), a peer-to-peer network, or some other type of network. Each of the computing devices described in the present disclosure may involve an Internet connection or some other type of local area network (LAN) or wide area network (WAN) connection. Non-limiting examples of structures that enable or form parts of a network include, but are not limited to, an Ethernet, twisted pair Ethernet, digital subscriber loop (DSL) devices, wireless LAN, WiFi, Worldwide Interoperability for Microwave Access (WiMax), cellular-infrastructure based devices, and the like.

FIG. 3 is a computing device embodiment 20. The computing device embodiment 20 of FIG. 3 may be representative of one or more computing devices arranged to carry out the acts of the event-to-spectator correlation tool 100 of FIG. 2. The computing device 20 of FIG. 3 may also be representative of one or more computing devices associated with spectators 104a-104n, one or more computing devices associated with venues 106a-106n, one or more computing devices associated with users 108a of the event-to-spectator correlation tool 100, and with third-party data sources 110. While each computing device of the present disclosure may be arranged, structured, and otherwise configured differently, it is understood that the computing device embodiment 20 of FIG. 3 is so illustrated as to not obscure or unnecessarily confuse one of ordinary skill in the art.

The computing devices discussed herein and represented by computing device embodiment 20 may include operative hardware found in conventional computing device apparatuses such as one or more processors 22, volatile and non-volatile transitory and non-transitory memory 24, serial and parallel input/output (I/O) circuitry 30 compliant with various standards and protocols, wired and/or wireless networking circuitry 32 (e.g., a communications transceiver), one or more user interface (UI) modules 34, logic, and other electronic circuitry.

In some cases, the computing device embodiment 20 will include optional logic modules. For example, when the computing device embodiment 20 is implemented as an event-to-spectator correlation tool 100, the computing device may include two optional logic modules. A first optional logic module is a total possible attendance (TPA), weighting factor adjustment, and likely attendance logic module 26. A second optional logic module is an optional machine learning feedback logic module 28.

Processors 22, as described herein, include central processing units (CPU's), microcontrollers (MCU), digital signal processors (DSP), application specific integrated circuits (ASIC), and the like. A processor 22 interchangeably refers to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory 24 or may be hard-coded as a state machine or set of control signals. According to methods and devices referenced herein, embodiments describe software executable by a processor 22 and operable to execute certain ones of the method acts.

As known by one skilled in the art, a computing device 20 has one or more memories 24, and each memory may comprise any combination of volatile and non-volatile computer-readable media for reading, writing, or reading and writing. Volatile computer-readable media includes, for example, random access memory (RAM). Non-volatile computer-readable media includes, for example, read only memory (ROM), magnetic media such as a hard-disk, an optical disk, a flash memory device, a CD-ROM device, and/or the like. In some cases, a particular memory is separated virtually or physically into separate areas, such as a first memory, a second memory, a third memory, etc. In these cases, it is understood that the different divisions of memory may be in different devices or embodied in a single memory. The memory 24 in some cases is a non-transitory computer medium configured to store software instructions arranged to be executed by a processor 22.

The computing devices 20 illustrated herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device 20 is a single hardware machine having at least some of the hardware and software listed herein, and in other cases, the computing device 20 is a networked collection of hardware and software machines working together in a server farm to execute the functions of one or more embodiments described herein. Some aspects of the conventional hardware and software of the computing device 20 are not shown in the figures for simplicity.

Database structures, if any are present or otherwise accessible to the computing device embodiment 20, may be formed in a single database or multiple databases. In some cases hardware or software storage repositories are shared amongst various functions of the particular system or systems to which they are associated. A database may be formed as part of a local system or local area network. Alternatively, or in addition, a database may be formed remotely, such as within a “cloud” computing system, which would be accessible via a wide area network or some other network.

Input/output (I/O) circuitry 30 and user interface (UI) modules 34 include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, computing devices 20 discussed herein may communicate with other devices via communication through a communications interface 32 via a network 102. The communications interface 32 may involve an Internet connection or some other type of local area network (LAN) or wide area network (WAN) interface. Non-limiting examples of structures that enable or form parts of a network include, but are not limited to, an Ethernet, twisted pair Ethernet, digital subscriber loop (DSL) devices, wireless LAN, WiFi, Worldwide Interoperability for Microwave Access (WiMax), or the like.

In some cases, the memory 24 described herein is a non-transitory computer readable medium (CRM). The CRM is configured to store computing instructions executable by a CPU of a computing device embodiment 20. The computing instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of a computing device embodiment 20.

Buttons, keypads, computer mice, memory cards, serial ports, bio-sensor readers, touch screens, and the like may, individually or in cooperation, be useful to an operator of a computing device embodiment 20. The devices may, for example, input control information into the system. Displays, printers, memory cards, LED indicators, temperature sensors, audio devices (e.g., speakers, piezo device, etc.), vibrators, and the like are all useful to present output information to the operator of the particular computing device embodiment 20. In some cases, the input and output devices are directly coupled to the particular computing device embodiment 20 and electronically coupled to a processor 22 or other operative circuitry. In other cases, the input and output devices pass information via one or more communication ports 32 (e.g., RS-232, RS-485, infrared, USB, etc.).

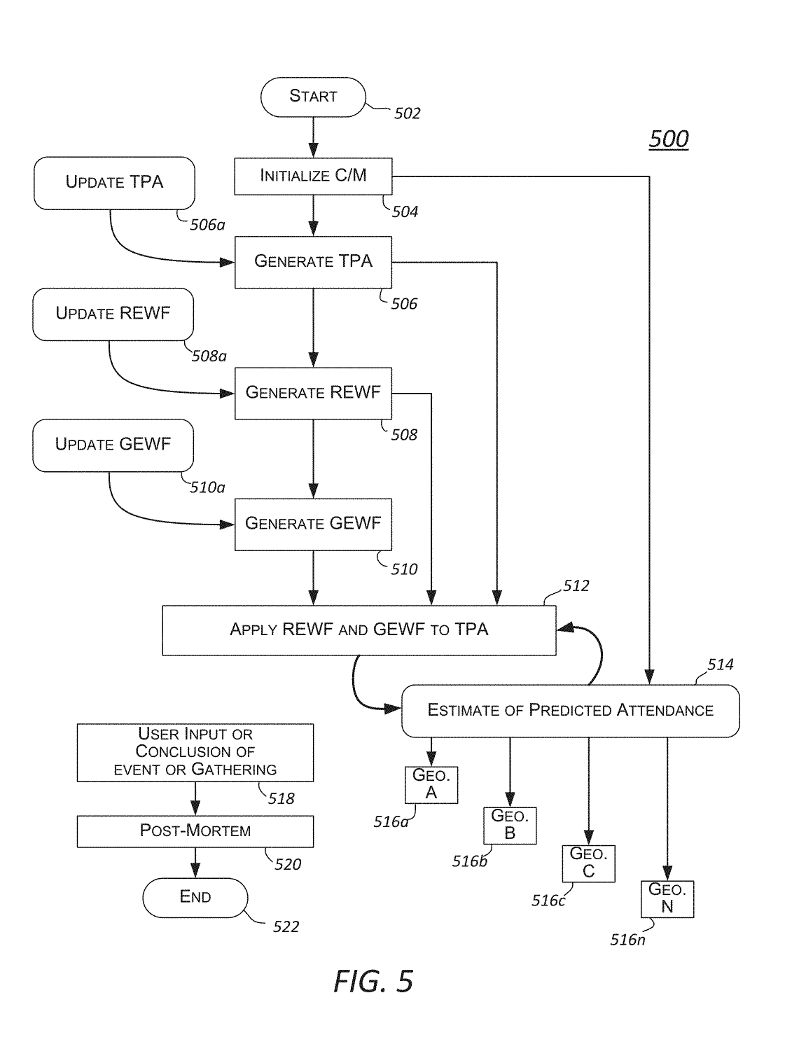

Certain figures in the present disclosure (e.g., FIGS. 5-7) include data flow diagrams illustrating non-limiting processes that may be used by embodiments of an event-to-spectator correlation system 100. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

Turning back to FIG. 2, the event-to-spectator correlation tool 100 embodiment is arranged as a machine-learning device to estimate an expected attendance at an event or at a gathering with substantial accuracy. As time passes, the event-to-spectator correlation tool 100 continues to collect data, analyze data, analyze results, and improve the accuracy of predictive attendance estimates for future events that have not yet occurred and that have not yet even been modeled. In other words, the computational model described herein makes predictions of attendance based on current data, and then the computational model analyzes results of the prediction, updates the computation model data, and improves the results of future attendance predictions even when the event or gathering to be predicted has parameters or characteristics that are new to the computational model. What's more, as time passes, and as the time for the event to begin approaches (i.e., as it gets closer to the event whose attendance was predicted), the computational model continues to operate. The computational model also continues update itself with new and refined data, and the computational model continues to improve the accuracy of the predicted attendance.

In FIG. 2, an embodiment of a system 10 implements an event-to-spectator correlation tool 100. Users 108a of the system 10 may enter particular details of any particular event or gathering. Along these lines, particular details of dozens, hundreds, or thousands of events may be automatically entered via any number of third-party data sources 110. Some of the particular details are entered by one source, and others of the particular details may be entered by one or more different sources. In addition, once some of the particular details are entered into the event-to-spectator correlation tool 100, the tool may determine other particular details. Some of the other particular details determined by the event-to-spectator correlation tool 100 are automatically determined, while other details are determined when the event-to-spectator correlation tool 100 automatically sends a request to a third-party data source 110. In still other cases, the event-to-spectator correlation tool 100 alerts a user 108a to enter such details. In some cases, all of the particular details are entered at a single time, and in other cases, certain details associated with the event are entered at one time and other details are entered at another time. For example, during a playoff season, one team may advance in the playoff round before that team's opponent is determined. In this case, the event of interest may be a coming playoff game, and particular details regarding the event may be received serially, separated by hours or days.

The particular details of an event or gathering captured by the event-to-spectator correlation tool 100 may include a year, a month, a day, and a time when the event will occur. The user or the third-party system 110 may enter a day of the week that the event will occur. Alternatively, the event-to-spectator correlation tool 100 may determine what day of the week the event will occur, or the event-to-spectator correlation tool 100 may query a same or different outside third-party data source 110 to determine what day of the week the event will occur. With respect to predicting attendance at an event or gathering, the year, month, day, time, and day of the week that an event will occur may each impact how many spectators will attend the event or occurrence.

Other particular details associated with the event or gathering may include the location of the event or gathering, the particular details related to the execution of the event or gathering. For example, if the event or gathering is directed toward a team sport, then the particular details may include the league, the teams, and other such information about the primary event itself. If the event or gathering is directed toward a television show, then the particular details may include the name of the television show, the date the show was taped, the date the show was first aired or advertised, and other such data. If the event or gathering is directed toward a trivia night, then particular details regarding the subject matter of questions may be entered along with certain demographic information associated with the invited or eligible participants. Other particular details associated with a trivia event or gathering, a team or individual sporting event, a political event, or any other conceivable event or gathering of interest to spectators may be entered.

Upon entry of the particular details, a total possible attendance (TPA) value for the event or gathering will be generated by the event-to-spectator correlation tool 100. The TPA is an estimate of all possible spectators to an event or gathering; and the TPA is not an estimate of all likely spectators to the event or gathering. Gathering of data to determine an estimate of all possible spectators is only one act of the computational model in the process to determine an estimate of likely spectators.

After determining an initial estimate of total possible attendance (TPA), the event-to-spectator correlation tool 100 may continue to update and refine the TPA estimate until the event or gathering is executed. For example, if the primary event of interest is a professional baseball game, an initial TPA estimate may be generated one week in advance of the ballgame, two weeks in advance of the ballgame, or at some other point before the ballgame takes place. After the initial TPA estimate is made, the TPA estimate may continue to be refined one or more times prior to the start of the ballgame. The number of times the TPA estimate is updated may be based on a schedule, on a random basis, after a manually-entered request basis, or on some other basis.

Considering the example of the professional baseball game, the estimate of TPA may change for any number of reasons. For example, if one or both of the baseball teams is winning more or fewer games, then a third-party data source 110 may report that the team's fan club is growing or shrinking. If there is on-field or off-field controversy, or if a team changes its advertising strategy, then the population of fans interested in the team may grow or shrink. Along these lines, if the fan-base to the game of baseball itself is changed after particular details associated with the event or gathering are entered into the event-to-spectator correlation tool 100 but before the game is played, then the total possible attendance number for the event or gathering may correspondingly change.

In addition to generating a TPA estimate, the event-to-spectator correlation tool 100 will also generate at least two particular types of weighting factors. A first weighting factor is a regional event weighting factor (REWF), and the second weighting factor is a global event weighting factor (GEWF). The REWF is an estimated weighting factor that corresponds to the popularity of the primary event in the location where the event or gathering of interest will be conducted. And the GEWF is an estimated weighting factor that corresponds to the popularity of the primary event overall and without particular respect to where the event or gathering of interest will be conducted.

Information used to generate the REWF and the GEWF may be entered via any number of spectators 104a-104n, venues 106a-106n, users 108a, and third-party data sources 110. In at least one embodiment, the REWF and the GEWF are estimates of popularity of an event or gathering generated as a real number that is normalized between zero (0) and one (1). In these types of embodiments, an event or gathering that is determined to not be popular at all and may, in fact, be completely unpopular, may assign a weighting factor of zero (0). Conversely in these types of cases, if the event or gathering is determined to be very, very popular, then a weighting factor of one (1) may be assigned. In this way, if a weighting factor is determined to be zero (0), then the event or gathering will be unpopular to the entire total possible audience (TPA), and an estimate of likely attendance will result in zero (0) spectators. And if a weighting factor is determined to be one (1), then the event or gathering will be very popular to each spectator of the entire TPA, and an estimate of likely attendance will be equal to the TPA. In this way, it is apparent if the REWF and the GEWF are between zero (0) and one (1), then the estimate of expected attendance at the event or gathering will be a proportional fraction of the estimated TPA.

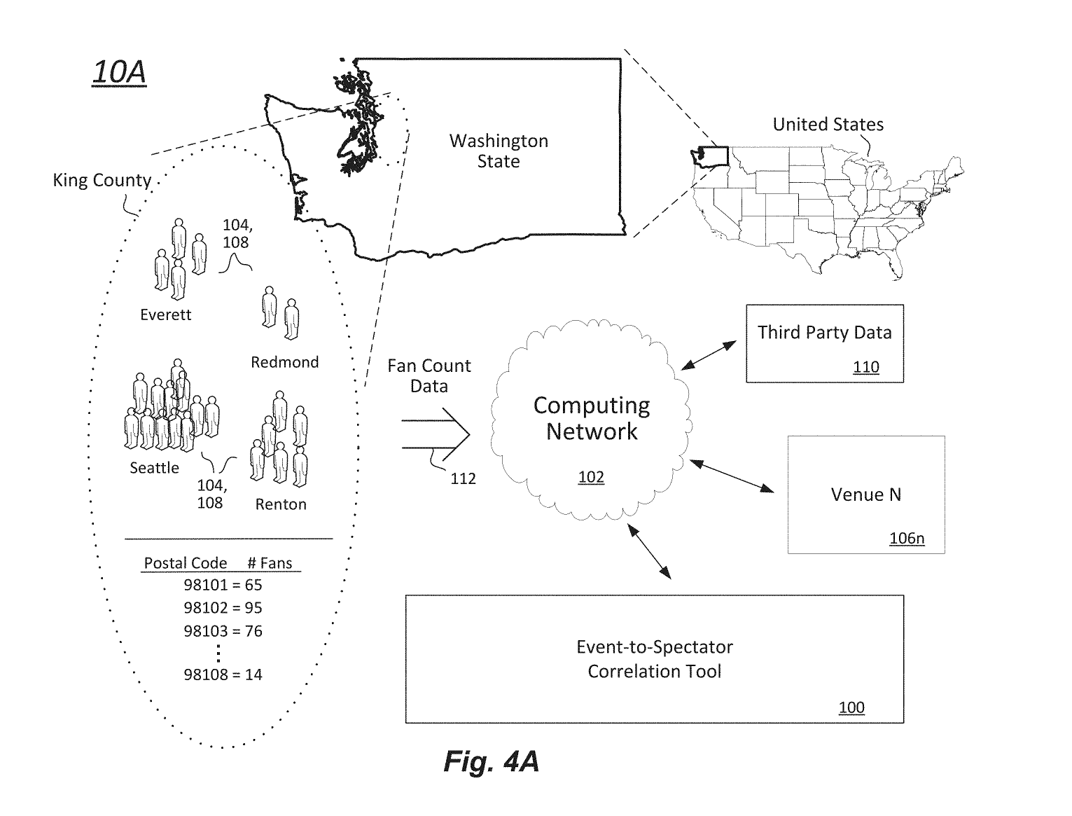

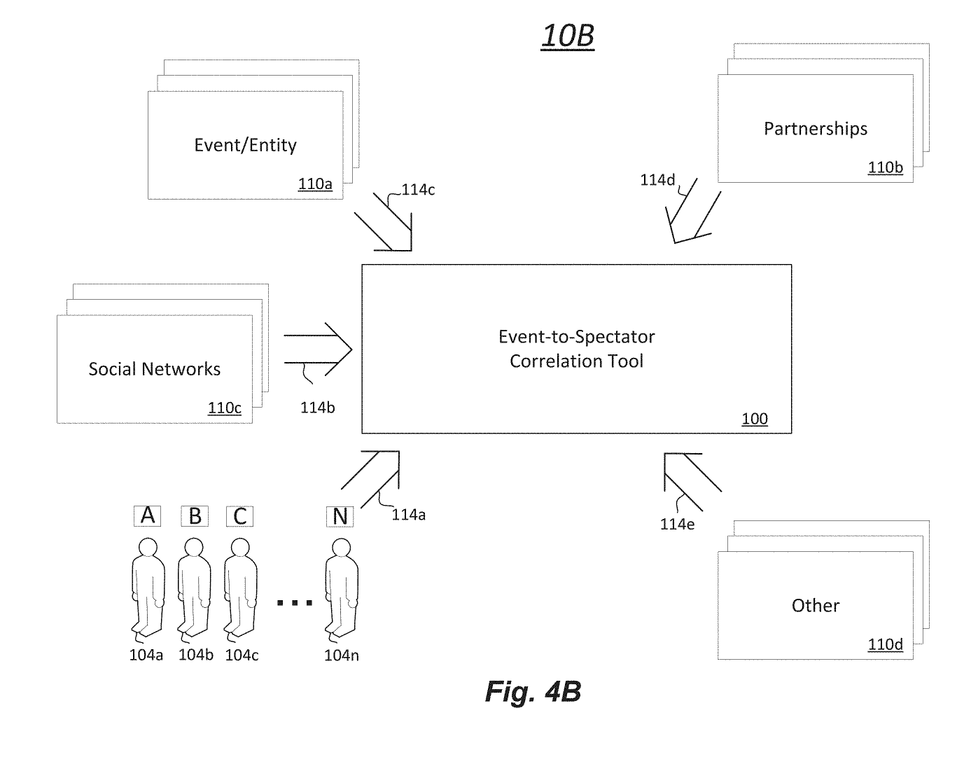

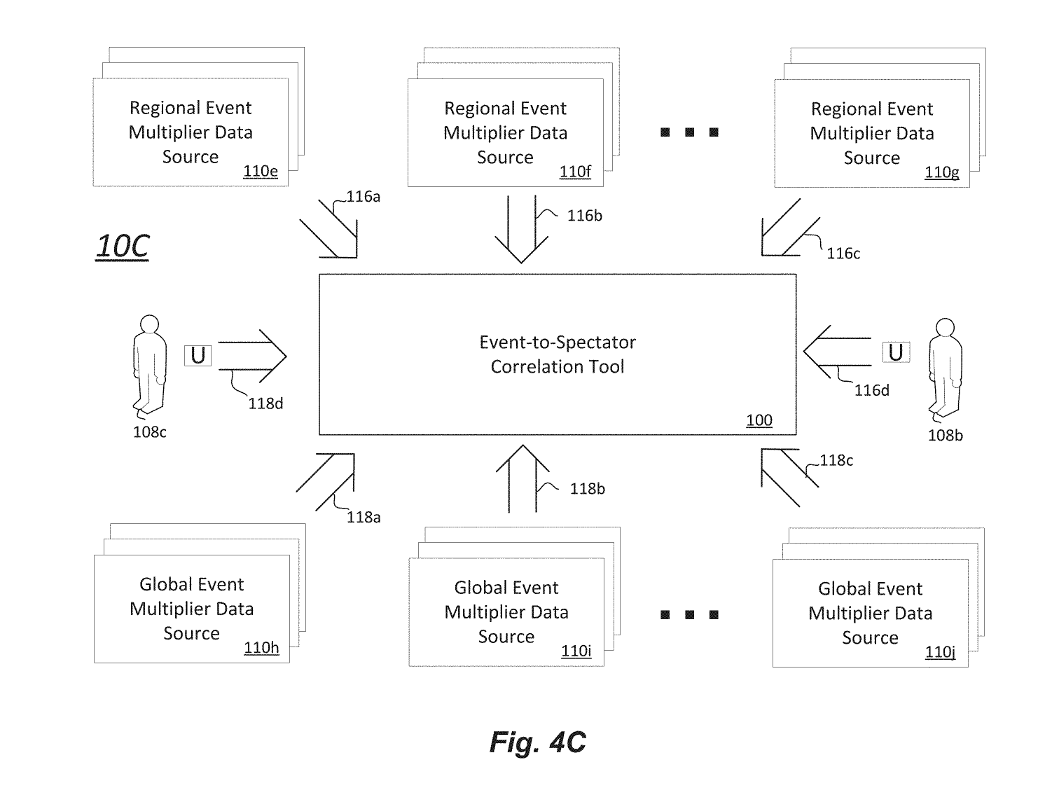

FIGS. 4A-4C may be collectively referred to as FIG. 4. As a whole, the figures of FIG. 4 provide additional information associated with an embodiment of a system 10 that implements an event-to-spectator correlation tool embodiment. The event-to-spectator correlation tool 100 of FIGS. 4A-4C is arranged to generate an estimate of expected attendance at a given event or gathering with substantial accuracy in accordance with Equation 4.

Estimated_Attendance=Recur[(TPA)×(REWF)×(GEWF)] (4)

wherein,
TPA=Total Possible Attendance;
REWF=Regional Event Weighting Factor;
GEWF=Global Event Weighting Factor; and
“Recur” indicates that the operations occur recursively.

In Equation 4, Total Possible Attendance (TPA) is an integer, and the Regional Event Weighting Factor (REWF) and Global Event Weighting Factor (GEWF) are real numbers normalized between 0.0 and 1.0.

FIG. 4A is a fan count data portion 10A of a system that implements an event-to-spectator correlation tool 100 embodiment. In FIG. 4A, an event-to-spectator correlation tool 100 cooperatively communicates across a computer network 102 with any number of venues 106n, any number of third-party data sources 110, and any number of spectators 104 and users 108. As is evident in FIG. 4A, data associated with particular spectators 104 and users 108, and data associated with other aspects of the event-to-spectator correlation tool 100 (e.g., venue 106 and third-party data source 110) are geographically associated at various levels, including at the world level, country level, the region level, the state level, the municipal or city level, and the postal code (e.g., zip code) level. Other levels of granularity are also contemplated.

With particular respect to FIG. 4A, information applied by, and generated in, the event-to-spectator correlation tool 100 is applied, generated, or applied and generated at a particular geographic level. FIG. 4A illustrates that such information may span any country (e.g., the United States), any state (e.g., Washington), any region, any county (e.g., King County), any city (e.g., Everett, Wash.; Redmond, Wash.; Seattle, Wash.; Renton, Wash.), any postal code, any combination of postal codes, and the like. Such geographically-based data may collectively be referred to as fan count data 112. It is understood that fan count data 112 may include information associated with venues, a third-party data sources, spectators 104, users, and even with the event-to-spectator correlation tool 100 itself.

FIG. 4B is an attendance data portion 10B of a system that implements an event-to-spectator correlation tool 100 embodiment. The attendance data portion 10B is configured to produce a substantially accurate estimate of total possible attendance (TPA) at a given event or gathering. As discussed with respect to FIG. 2, one or more initial estimates of a number of spectators to a given event or gathering may be made. The data that is used to initialize the TPA estimate may be provided by any number of third-party data sources 110. The initial TPA estimate may be derived from fan club data, student populations, data from employee handbooks, and the like.

FIG. 4B illustrates additional sources of TPA raw data information. The raw data information may be provided by spectators 104a-104n as attendance data 114a, by social networks 110c as attendance data 114b, by events or entities 110a as attendance data 114c, by partnerships as attendance data 114d, and in addition, or in the alternative, by other third-party data sources 110d as attendance data 114e. In addition, each of the third-party data sources 110a-110d may also provide additional information from which to adjust a working or otherwise current TPA estimate value.

In some cases, an operator of an event-to-spectator correlation tool 100 may permit some spectators 104a-104n to have direct access to features associated with the event-to-spectator correlation tool 100. The operator of the event-to-spectator correlation tool 100 may, for example, create one or more social-network-based fan groups directed to any number of events and event circumstances. A non-limiting and non-exhaustive list of such fan groups may include such groups descriptively entitled “Boston Red Sox Fans In Seattle,” “Republicans In Seattle,” “Chocolate Lovers In Atlanta,” and the like. In this way, spectators, via a social network third-party data source 110c, may self-report their status in a particular TPA estimate covering a determined event and a determined location. Using the non-limiting examples, members of the “Boston Red Sox Fans In Seattle” fan group may be some portion of a total possible audience (TPA) of an event or gathering associated with a Boston Red Sox game scheduled to play at Safeco Field in Seattle on a particular day at a particular time.

Event/Entity third-party data sources 110a may also provide information used to populate or adjust a particular TPA estimate for a particular event or gathering. Such information is shown as attendance data 114c in FIG. 4B. For example, a league, a sports team, an automotive club, a celebrity, or any other event or entity may administer its own fan club. Based on a known or otherwise associated geographic location, the event or entity may be able to report a particular fan base or number of fans to the event-to-spectator correlation tool 100, which may then be used to determine or adjust a particular TPA estimate associated with a particular event or gathering.

Certain third-party partnership data sources 110b may provide attendance data 114d along the lines of other third-party data sources. A partnership may, for example, include a fan-base for a team in a particular area, customers of particular merchandise, attendees to a particular venue, and the like. In one case, a professional basketball team from one city or state may provide attendance data 110d that includes a size of a fan pool for the team in Miami or some other geographic location. As another example, organizers of a major car race in Indianapolis, Ind., may provide attendance data 114d indicating postal codes, cities, or other geographic information for one or more groups of previous race attendees. In return, the operator may use the information to provide audience estimate data used for television coverage pricing, merchandise sale preparations, preferred accommodation providers, and the like.

Along the lines of other third-party data sources described herein, an “other” third-party data source 110d may also provide attendance data 114e to the event-to-spectator correlation tool 100. The other third-party data source 110d may provide information used to create or adjust a TPA estimate. Examples of “other” third-party data sources 110d or other formulations of attendance data 114 include data collected at in-person events, by direct or indirect advertising, by purchased lists of prospective spectators, or by any other spectator acquisition technique.

In preparation and execution of a computational model to create an estimated audience, the event-to-spectator correlation tool 100 will create an initial estimate of total possible attendance (TPA) for the particular event or gathering. The initial estimate may be a specific information datum such as a total number of fan club members or past attendees in a geographic area, or the initial estimate may be arrived at in a different way. The initial estimate will be based on a determined geographic basis. That is, the TPA estimate will be associated with a state, a county, a city, a postal code, a group of postal codes, a group of cities, a group of states, or some other geographic representation. In some cases, the event-to-spectator correlation tool 100 will create and maintain a plurality of TPA estimates for a given event or gathering such that each TPA estimate is associated with a different geographic representation.

After the initial one or more TPA estimates is created, the event-to-spectator correlation tool 100 will recursively adjust the one or more TPA estimates. Adjustments to a TPA estimate is performed so as to count each prospective spectator to a given event or gathering only one time. In other words, if an initial TPA estimate for a certain golf tournament, for example, is based on fans of a certain social network golf-tournament-fan-club-in-a-certain-city, then it is likely that at least some members of a golf club in the certain city are also members of the selected fan club. Accordingly, if a third-party data source 110 provides information to the event-to-spectator correlation tool 100 that includes the total number of social network golf-tournament-fan-club-in-a-certain-city members and the total number of members in the golf club in the certain city, then the event-to-spectator correlation tool 100 could not simply add the two numbers together. Instead, the event-to-spectator correlation tool 100 will set the TPA estimate to a first one of the numbers, add the second one of the numbers, and then attempt to remove the proper number of “duplicate” members.

The event-to-spectator correlation tool 100 may remove duplicate members of any TPA estimate in any way. For example, in some cases, usernames may be compared, and when duplicate usernames are encountered, a TPA estimate is reduced by one. In these cases, the event-to-spectator correlation tool 100 may capture the duplicate information for use in other parts of the computational model. Another way that the event-to-spectator correlation tool 100 operates to avoid counting duplicate members of a TPA estimate is by identifying other types of duplicated information such as Internet Protocol (IP) addresses, media access control (MAC) addresses, mobile telephone numbers, universally unique identifiers (UUID's), global positioning system (GPS) or other geolocation information, pattern recognition in comments or other entries in social network websites, data scraping, and the like. In these cases, no personally identifying information is captured or used to in the TPA estimate or adjustment, but such techniques may be used to reduce the likelihood of over-counting or under-counting in a TPA estimate.

Additional techniques may also be used to recursively update a generated TPA estimate. For example, in some cases, a ticket sales entity is a third-party data source 110. In this case, particular information may be used to raise the confidence or lower the confidence in a TPA estimate. In cases where confidence is raised, one or more TPA estimates may be adjusted in one direction, and in cases where TPA estimate confidence is lowered, then one or more TPA estimates may be adjusted in another direction.

The techniques described herein to determine and recursively adjust a TPA estimate are non-exhaustive and non-limiting. Some techniques may not be performed, and other techniques may be performed. In some cases, as a day and time for a given event or gathering approaches, the frequency at which data is solicited, collected, or solicited and collected may be adjusted. Along these lines, in some cases, the frequency at which one or more TPA estimates are adjusted may also be adjusted based on a current day and time relative to a day and time that the given event or gathering is scheduled.

FIG. 4C is a regional and global event multiplier portion 10C of a system that implements an event-to-spectator correlation tool 10 embodiment. In FIG. 4C, a first plurality of third-party data sources 110e-110g provide regional event multiplier data 116a-116c, and a second plurality of third-party data sources 110h-110j provide global event multiplier data 118a-118c. In addition, one or more users 108b, via an associated computing device U, provide regional event multiplier data 116d, and one or more users 108c, via an associated computing device U, provide global event multiplier data 118d. Any number of third-party data sources may be provided to generate, provide, or otherwise communicate regional and global event multiplier data.

Using the regional event multiplier data 116a-116d, the event-to-spectator correlation tool 100 recursively generates and re-generates a regional event weighting factor REWF, and using the global event multiplier data 118a-118d, the event-to-spectator correlation tool 100 recursively generates and re-generates a global event weighting factor GEWF.

Turning back to FIG. 3, the optional logic modules of the computing device 20 may be implemented by the structures represented in FIGS. 4B and 4C. More specifically, the TPA, weighting factor adjustment, and likely attendance logic module 26 may be implemented to create an estimate of total possible attendance (TPA). This module may also operate to create the regional and global event multipliers. Cooperatively, the machine learning feedback logic module 28, when implemented, directs the recursive operations of the event-to-spectator correlation tool 100. The machine learning feedback logic module 28 may operate to direct the collection and re-collection of particular data, and the module may also operate to direct the re-calculation of one or more contributors to the TPA estimate and one or more contributors to any weighting factor.

FIG. 5 is a first data flow 500 illustrating an embodiment of a process that recursively generates an estimate of predicted attendance at a given event or gathering. Operations of the first data flow 500 may be implemented in whole or in part in one or both of the optional logic modules of FIG. 3 (i.e., the “Total Possible Attendance, Weighting Factor Adjustment, and Likely Attendance Logic” module 26 and the “Machine Learning Feedback Logic” module 28 of FIG. 3).

In some cases, a plurality of first processes of FIG. 5 are instantiated on a computing device 20 (FIG. 3), which may be a distributed computing system that is scalable to provide as many resources as needed by the particular number of instantiated processes. For example, if an estimate of predicted attendance is sought for a first given event or gathering, then a single instance of the first data flow 500 is instantiated. In addition, or in the alternative, if estimates of predicted attendance for two different events or gatherings are sought, then two instances of the first data flow 500 are instantiated. Along these lines, if estimates of predicted attendance for 10 events or gatherings, 100 events or gatherings, or thousands of events or gatherings are sought, then 10, 100, or thousands of instances of the first data flow 500 are instantiated in the computing device 20. Operations of the processes of FIG. 5 may be used to carry out acts of Equation 1 or Equation 4 of the present disclosure.

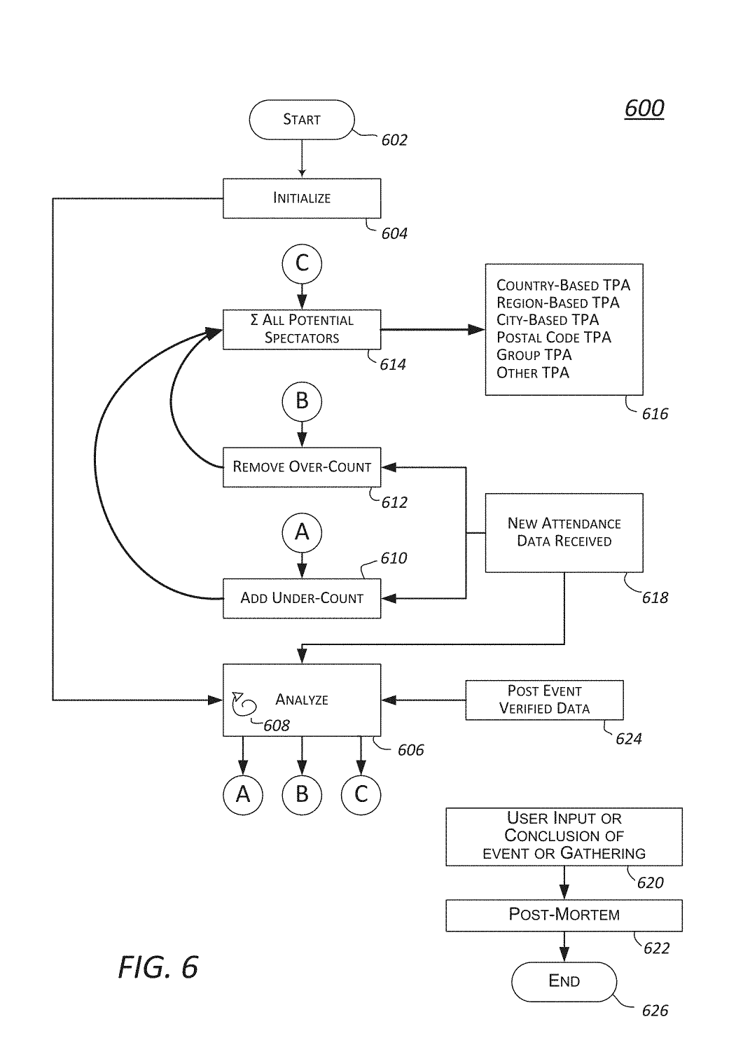

Along the lines of instantiating the first data flow 500 of FIG. 5, other processes as described in the present disclosure (e.g., second data flow 600 of FIG. 6) may also be instantiated. In this way, any one or more processes of the computational model of the event-to-spectator correlation tool 100 in the present disclosure is very highly scalable. So as to not obscure the essence of particular features of interest of the event-to-spectator correlation tool 100, the processes and data flow diagrams described herein are generally associated with data calculations for a single or small number of events and gatherings.

Operations of the first data flow 500 begin at 502, and processing advances to an initialization stage at 504. At 504, variables of a computation model of an event-to-spectator correlation tool 100 are initialized. Such initialization may include creating temporary working variables and structures, establishing network communications, loading data from internal and external databases, requesting data, providing directions and alerts to users, and other such initialization procedures. In some cases, the creation of temporary working values includes creation of an initial value of a total possible attendance (TPA) for a given event or gathering. Initial values for one or more regional event weighting factors and global event weighting factors may also be loaded.

Upon initialization at 504, operations of the first data flow 500 execute substantially in parallel, and often asynchronously. In some cases, the operations are multitasked in a singly-threaded system. In this way, the appearance of parallel processing is provided, but operations actually occur serially. In other cases, the computing device 20 (FIG. 3) that carries out acts of the first data flow 500 includes a plurality of processors, and operations of the first data flow 500 actually occur in parallel.

As shown in the first data flow 500 of FIG. 5, effects of processing in several modules cascade into other modules. This illustration represents data being synchronously or asynchronously updated in one module, and the updated data being used in another module. Whether cascading or operating in parallel, processing of the first data flow 500 passes to any one or more of a module to generate a total possible attendance (TBA) at 506, a module to generate a regional event weighting factor (REWF) at 508, and a module to generate a global event weighting factor (GEWF) at 510. Processing may also pass to 514 where at least one estimate of predicted attendance for a given event or gathering is generated.

At 506, a total possible attendance (TPA) for the event or gathering is generated. Operations of the module at 506 are recursive and on-going. Input data for the TPA calculation may be updated at 506a. Such updating may be from zero to many times. The updating may occur at regular intervals, randomly, or in any other way. For a particular event or gathering, any number of TPA estimates may be generated for any number of geographic areas. For example, estimates of a TPA may be generated for a country, a region, a state, a county, a city, a postal code, a group of postal codes, or for some other determined region. In some cases, the determined geographic region of interest is manually determined by a particular user.

At 508, a regional event weighting factor (REWF) for the event or gathering is generated. Determining such an REWF may be considered to represent a regional popularity of the given event or gathering. Operations of the module at 508 are recursive and on-going. Input data for the REWF calculation may be updated at 508a. Such updating may range from zero to many times. The updating may occur at regular intervals, randomly, or in any other way. For a particular event or gathering, any number of REWF estimates may be generated for any number of geographic areas. For example, estimates of an REWF may be generated for a country, a region, a state, a county, a city, a postal code, a group of postal codes, or for some other determined region. In some cases, the determined geographic region of interest is manually determined by a particular user.

At 510, a global event weighting factor (GEWF) for the event or gathering is generated. Determining such an GEWF may be considered to represent a global popularity of the given event or gathering. Operations of the module at 510 are recursive and on-going. Input data for the GEWF calculation may be updated at 510a. Such updating may be from zero to many times. The updating may occur at regular intervals, randomly, or in any other way. For a particular event or gathering, any number of GEWF estimates may be generated for any number of geographic areas. For example, estimates of a GEWF may be generated for a country, a region, a state, a county, a city, a postal code, a group of postal codes, or for some other determined region. In some cases, the determined geographic region of interest is manually determined by a particular user.

Processing at 512 applies a current REWF and a current GEWF to a current TPA. Such processing cooperatively attenuates a current estimate of total possible attendance at a given event or gathering based on a combination of regional popularity of the event or gathering and global popularity of the event or gathering. The processing at 512 may carry out operations of Equation 1 or Equation 4 of the present disclosure. Accordingly, the processing at 512 may include multiplying the total possible value by a regional event weighting factor to produce a first product and multiplying the first product by a global event weighting factor to produce a second product. The second product is a current estimate of predicted attendance.

The estimate of predicted attendance may be further amended and processed at 514. For example, at 514, several estimates of predicted attendance at the given event or gathering are produced. A first estimate is associated with a first geographic area at 516a, a second estimate is associated with a second geographic area at 516b, a third estimate is associated with a third geographic area at 516c, and a fourth estimate is associated with a fourth geographic area at 516n. Any number of estimates of predicted attendance can be generated for any number of geographic areas. For example, one of the geographic areas (516a-516n) may represent an estimate of predicted attendance within a postal code, and another one of the geographic areas may represent an estimate of predicted attendance within a group of two or three adjacent postal codes. Still one more or the of the geographic areas may represent an estimate of predicted attendance within an entire city or county.

Using the output at module 514, one or more estimates of predicted attendance at a given event or gathering may be used to direct spectators to a particular bar, restaurant, or another venue.

For example, if a particular event or gathering is analyzed by the event-to-spectator correlation tool 100, it may be determined that only 20 or 30 spectators are estimated to view a given event in a particular postal code. Such analysis may concurrently determine that in a group of three or four adjacent postal codes, a total of 120 spectators are estimated to view the given event. In view of the generated estimate, an operator of the event-to-spectator correlation tool 100 may share the estimate of predicted attendance with a particular venue. The venue may choose to target advertising or particular promotional material within that block of adjacent postal codes. The additional, target advertising will be directed toward the total possible attendance (TPA) group calculated in module 506, but only a portion of the TPA group will actually attend the event. The portion of the TPA group that actually attends the event (i.e., the number of spectators that actually attends the event) is likely to be, with substantial accuracy, the same number of spectators calculated at modules 512 and 514. Stated differently, the number of spectators calculated for the TPA group will have been attenuated by the REWF calculated at module 508 and further attenuated by the GEWF calculated at module 510. Using the predicted estimate, the venue will conduct the event or gathering (e.g., a viewing party for a sporting event, a political convention, or some other event or gathering), receive the participants at the venue, and count the participants at the venue.

Processing in the first data flow 500 will be ongoing until a user ends the processing or until the given event or gathering of interest concludes. In such case, processing occurs at 518 and falls to 520. At 520, the results of earlier calculations are analyzed, data is collected, and data is fed back into the event-to-spectator correlation tool 100. Such data may be used to improve later calculations, determine accuracy of the calculations, and for other reasons.

Processing of the first data flow 500 ends at 522.

FIG. 6 is a second data flow 600 illustrating an embodiment of a process that recursively generates an estimate of total possible attendance at a given event or gathering. The estimate of total possible attendance (TPA) may be applied in Equation 1 or Equation 4 of the present disclosure. Operations of the second data flow 600 may be implemented in whole or in part in one or both of the optional logic modules of FIG. 3 (i.e., the “Total Possible Attendance, Weighting Factor Adjustment, and Likely Attendance Logic” module 26 and the “Machine Learning Feedback Logic” module 28 of FIG. 3).

Operations of the second data flow 600 begin at 602, and processing advances to an initialization stage at 604. At 604, certain variables of a computation model of an event-to-spectator correlation tool 100 are initialized. The particular variables are generally associated with calculations of an estimate of total possible attendance (TPA). Such initialization may include creating temporary working variables and structures, establishing network communications, loading data from internal and external databases, requesting data, providing directions and alerts to users, and other such initialization procedures. In some cases, the creation of temporary working values includes creation of an initial value of a total possible attendance (TPA) for a given event or gathering. Initial values for one or more over-count variables, under-count variables, and other variables may also be loaded.

Upon initialization at 604, operations of the second data flow 600 pass to processing at an analysis module 606. The processing in the analysis module 606 is recursive 608 and ongoing. In other words, until a processing of the second data flow 600 is stopped by user input, conclusion of the event or gathering, or for some other reason, then new attendance data is received at module 618, and the new data is processed in the analysis module 606.

At module 618, the new attendance data may be updated from zero to many times. The updating may occur at regular intervals, randomly, or in any other way. For a particular event or gathering, any number of new attendance estimates may be generated for any number of geographic areas.

The new attendance data and other data is processed in a recursive manner in the analysis module 606. The recursive processing may include one or more attendance adjustment factors. The attendance adjustment factors may include, but are not limited to, any one or more of 1) event data, 2) number-of-estimated-participants, 3) number-of-registered-participants, 4) participant-data, 5) regional-data, 6) third-party-data, and 7) wildcard-factors. Such attendance factors are discussed in detail in the present disclosure.

Results of the analysis module at 606 are processed in modules 610, 612, and 614.

At module 610, data from the analysis module 606 and new attendance data from module 618 is processed to upwardly adjust a total possible attendance estimate. At module 612, data from the analysis module 606 and new attendance data from module 618 is processed to downwardly adjust a total possible attendance estimate. The results of processing at modules 610 and 612 are processed in module 614.

A sum of total possible spectators to a particular event or gathering is calculated as an estimate of total possible attendance (TPA) in module 614. The particular TPA estimate is based on a particular geographic area. Such processing based on a geographic area is carried out in module 616. For example, an estimate of TPA at an event or gathering may be generated for a country, a region, a state, a county, a city, a postal code, a group of postal codes, or for some other determined region. In some cases, the determined geographic region of interest is manually determined by a particular user. The TPA estimates calculated at module 616 may be cooperatively used in the first data flow 500 of FIG. 5.

Processing in the second data flow 600 will be ongoing until a user ends the processing or until the given event or gathering of interest concludes. In such case, processing occurs at 620 and falls to 622. At 622, the results of earlier calculations are analyzed. Data collected at module 622 may be cooperatively processed at module 624, and the data from module 624 may be passed into the analysis module 606. In addition, or in the alternative, data from the post-mortem module 622 may be fed back into the event-to-spectator correlation tool 100. Such data may be used to improve later calculations, determine accuracy of the calculations, and for other reasons.

Processing of the second data flow 600 ends at 626.

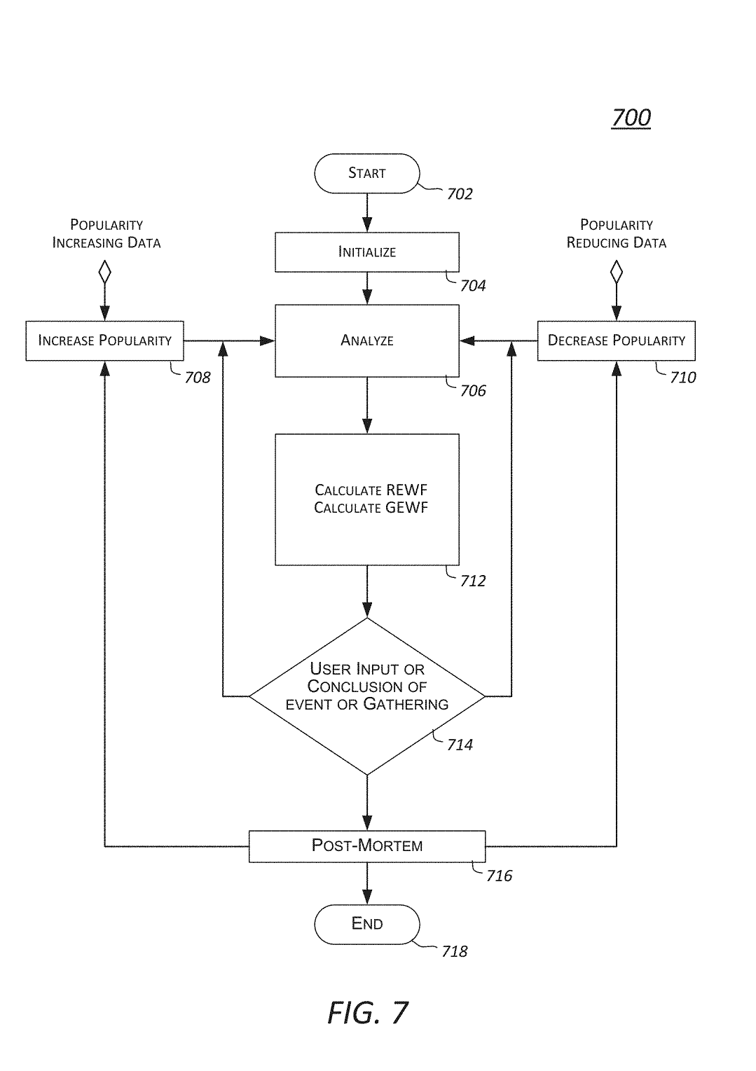

FIG. 7 is a third data flow 700 illustrating an embodiment of one or more processes that recursively generate estimates of regional and global weighting factors associated with a given event or gathering. The regional event weighting factor (REWF) and the global event weighting factor (GEWF) are applied in Equation 1 and Equation 4 of the present disclosure. Operations of the third data flow 700 may be implemented in whole or in part in one or both of the optional logic modules of FIG. 3 (i.e., the “Total Possible Attendance, Weighting Factor Adjustment, and Likely Attendance Logic” module 26 and the “Machine Learning Feedback Logic” module 28 of FIG. 3).

Operations of the third data flow 700 begin at 702, and processing advances to an initialization stage at 704. At 704, certain variables of a computation model of an event-to-spectator correlation tool 100 are initialized. The particular variables are generally associated with calculations related to a regional event weighting factor (REWF) and calculations related to a global event weighting factor (GEWF). Initialization may include the creation of temporary working variables and structures, the establishment of network communications, loading data from internal and external databases, requesting data, providing directions and alerts to users, and other such initialization procedures. In some cases, the creation of temporary working values includes creation of initial REWF and GEWF values for a given event or gathering. Initial values for one or more raise-popularity variables, lower-popularity variables, and other variables may also be loaded.

In some cases, the initial regional event weighting factor is considered to be “average popularity,” which, for example, may be 0.5. In other words, a temporary “regional” working variable may be loaded with the initial regional event weighting factor, which is 0.5. Along these lines, a temporary “global” working variable may also be loaded with a value of 0.5 to indicate average global popularity. In other cases, such as when the event-to-spectator correlation tool 100 has been processing multiple events or gatherings, and such as when the event-to-spectator correlation tool 100 has been operating for some period of time, the temporary regional working variable and temporary global working variable are maintained or otherwise loaded using previously determined values.

Processing after initialization falls to 706, which is an analysis stage. The analysis module at 706 takes input from an “Increase Popularity” stage 708 and a “Decrease Popularity” stage 710. The increase and decrease popularity stages 708, 710, respectively, receive “Popularity Increasing Data” and “Popularity Decreasing Data” synchronously, asynchronously, randomly, or at any suitable time. Data that represents increasing or decreasing popularity may be entered into the event-to-spectator correlation tool 100 manually, electronically, or in another way. In some cases, the increase and decrease popularity stages 708, 710 are modules, processes, or other logic that operate concurrently and in parallel. For example, in some cases, increase and decrease popularity stages 708, 710 are implemented partially or wholly in separate hardware circuits. In other cases, increase and decrease popularity stages 708, 710 are implemented partially or wholly using different processing cores of a multi-core processor, or different processors entirely. Such implementations enable real-time input to increase and decrease popularity data.

In some cases, increasing or decreasing popularity data affects weighting factors at a regional level, and in other case, increasing or decreasing popularity data affects weighting factors at a global level. Non-exclusively, and non-exhaustively, various data that affects a regional weighting factor includes any one or more of: 1) conflicting factors, 2) economic factors, 3) historical participation rate factors, 4) human and social demographic factors, 5) regional demographic factors, 6) political factors, 7) time factors, 8) third-party data factors, 9) unplanned acts factors, 10) weather factors, and 11) regional wildcard factors. Along these lines, non-exclusively, and non-exhaustively, various data that affects a global weighting factor includes any one or more of: 1) type-of-event factors, 2) nature-of-event factors, 3) status-of-individual-event-participant factors, 4) current-and-historical-performance factors, 5) calculated-or-estimated-excitement/engagement-level factors, 6) estimated electronic-or-live-viewing-attendance factors, 7) third-party-data factors, and 8) global-wildcard-factors.

The increasing popularity data and decreasing popularity data is analyzed in analysis module 706. In some embodiments, each datum is assigned a real number weighting factor normalized between 0 and 1. Each of the relevant weighting factors is then passed to the weighting factor calculation module 712, where the REWF and GEWF are calculated. In some cases, REWF and GEWF are each calculated as a product of all of the relevant weighting factors generated in the analysis stage 706. In other cases, REWF and GEWF are each calculated as a sum of all of the relevant weighting factors generated in the analysis stage 706. In yet other cases, REWF and GEWF are calculated in a different way.

In module 712, current versions of REWF and GEWF are calculated. The REWF and GEWF are available in the computational model implemented by the event-to-spectator correlation tool 100. For example, in some cases, REWF and GEWF are available for application in Equation 1 and Equation 4 of the present disclosure.

At 714, processing is determined to close or continue. Sometimes, a particular input, such as a user input, terminates the processing, and in such cases, processing falls to a post-mortem stage at 716. In addition, or alternatively at 714, if the event or gathering of interest concludes, the processing falls to a post-mortem stage at 716. At 716, certain post-mortem data is captured, collected, or otherwise determined. The post-mortem data may include actual attendance at the event or gathering of interest, additional factors relevant to the actual attendance that may not have been previously known or ascertainable (e.g., feedback from actual human attendees, moving or still images from the event or gathering, audio data, and the like).

Alternatively at 714, if processing is not concluded, then processing is returns to the analysis stage 706. In this way, operations of the third data flow 700 may be perpetual.

Processing in the analysis stage 706 may be perpetual, and in some cases, one or more portions of processing in the analysis stage 706 include machine learning processes. Operations of the analysis stage 706 may include pattern recognition and statistical analysis processes that facilitate certain attendance prediction features of the computational model that is implemented in the event-to-spectator correlation tool 100. Data in the analysis stage 706 is used recursively to apply otherwise undiscoverable insights to the determination of REWF and GEWF. Data from the current event or gathering of interest may be cooperatively combined with current and historical data from dozens, hundreds, and thousands of other events or gatherings. In some cases, the data analysis includes facial recognition, object recognition, audio recognition, or other such analysis of multimedia (e.g., video, still images, audio) captured during a post-mortem stage 716. Such analysis may provide data regarding crowd sizes, noise, facilities, and the like that is later applied to more effectively weight a total possible attendance (TPA) value.

Turning back to processing at 716, after the completion of post-mortem operations, processing falls to 718. The third data flow 700 ends at 718.

In the present disclosure, a plurality of attendance adjustment factors have been described, which may be cooperatively executed using the structures of the system 10 that implements an event-to-spectator correlation tool 100 illustrated in FIGS. 2, 3, 4A, and 4B. Also in the present disclosure, a plurality of regional and global event weighting factor adjustment inputs have been described, which may be cooperatively executed using the structures of the system 10 that implements an event-to-spectator correlation tool 100 illustrated in FIGS. 2, 3, and 4C.

The terms, “real-time” or “real time,” as used herein and in the claims that follow, are not intended to imply instantaneous processing, transmission, reception, or otherwise as the case may be. Instead, the terms, “real-time” and “real time” imply that the underlying thing occurs over an acceptably short period of time (e.g., over a period of seconds or minutes), and that the thing may be performed on an ongoing basis (e.g., updating weighting factors, updating total possible attendance, and the like). An example of a thing that is not real-time is one that occurs over an extended period of time (e.g., hours or days) or that occurs based on intervention or express direction by a person or some specific thing.

Where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent (30%). For example, predicting an expected attendance with substantial accuracy may be described as a predicting attendance at or within 30% of an actual attendance. Different from the exact precision of the term, “accurate,” the use of “substantially” to modify the characteristic permits a variance of the total possible attendance by up to 30% from the actual attendance. For example, if an expected audience is estimated to be 500 spectators, then an actual audience of 350 to 650 spectators would indicate that the estimate of 500 spectators was substantially accurate. As another example, if an expected audience at a venue is estimated to be between about 100 and 150 spectators, then an actual audience between 70 and 195 spectators will indicate that the estimate had substantial accuracy.

In the foregoing description, certain specific details are set forth to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or ideas.

The headings and Abstract of the Disclosure provided herein are for convenience only and do not limit or interpret the scope or meaning of the embodiments.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

The various embodiments described above can be combined to provide further embodiments. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of executing a gathering to view an event at a venue, comprising:
predicting an expected attendance at the venue, by:
determining a total possible attendance;
determining a regional popularity of the event;
determining a global popularity of the event; and
cooperatively attenuating the total possible attendance based on a combination of the regional popularity of the event and the global popularity of the event;
passing the predicted expected attendance to the venue; and
conducting the event by:
receiving participants at the venue; and
counting the participants at the venue.

2. A method according to claim 1 wherein the venue includes a computing device associated with the venue and wherein the venue is at least one of a restaurant, a bar, an auditorium, a stadium, a museum, a theater, an airport, a park, a hotel, a motel, a public meeting room, a domicile, and a park.

3. A method according to claim 1 wherein the event is at least one of a sporting event, a music concert, and a political event.

4. A method according to claim 1 wherein predicting the expected attendance includes:
multiplying a first value, a second value, and a third value, wherein the first value represents the total possible attendance, wherein the second value represents the regional popularity of the event, and wherein the third value represents the global popularity of the event.

5. A method according to claim 4 wherein the first value is an integer and wherein the second value and the third value are real numbers.

6. A method according to claim 4 wherein determining the total possible attendance comprises:
receiving, at a distributed computing server, location information associated with a determined number of interested parties, wherein each of the determined number of interested parties has assigned thereto an expressed interest in at least one of the event and the venue; and
generating, with the distributed computing server, the first value as an accumulation of interested parties having at least some common location information.

7. A method according to claim 6 wherein the location information includes at least one of a postal code, a portion of an internet protocol (IP) address, and global positioning system (GPS)-based information.

8. A method according to claim 7 wherein the at least some common location information includes a plurality of postal codes, a plurality of IP address portions, and a geographic location within a determined geographic area.

9. A method according to claim 4 wherein determining the regional popularity of the event comprises:
establishing, at a distributed computing server, a regional popularity baseline value representing an average regional event with average regional popularity;
setting, with the distributed computing server, a regional popularity working value to the regional popularity baseline value; and
updating, with the distributed computing server, the regional popularity working value by increasing or decreasing the regional popularity working value based on individual values of a set of determined regional popularity factors, the set of determined regional popularity factors including one or more of:
a conflicting event factor;
a local economic indicator;
a previous participation factor;
a social demographic factor;
a political factor;
a local population density factor;
a time-of-event factor;
a third-party social media data factor;
a weather forecast factor;
a local availability of electronic delivery of the event factor; and
a wildcard factor.

10. A method according to claim 4 wherein determining the global popularity of the event comprises:
establishing, at a distributed computing server, a global popularity baseline value representing an average global event with average global popularity;
setting, with the distributed computing server, a global popularity working value to the global popularity baseline value; and
updating, with the distributed computing server, the global popularity working value by increasing or decreasing the global popularity working value based on individual values of a set of determined global popularity factors, the set of determined global popularity factors including one or more of:
a team win/loss record;
a nature of the event factor;
a factor representing status of individual participants;
a current performance factor;
an historical performance factor;
a determined excitement factor;
a competing-events factor;
an estimated viewing attendance factor;
a third-party social media data factor; and
a wildcard factor.

11. A non-transitory computer-readable storage medium whose stored contents configure a computing system to perform a method, the method comprising:
electronically receiving information at a computing device, the information representing a primary event of interest, wherein the computing device is communicatively coupled to the computing system;
identifying with the computing device a plurality of geographic regions having access to the primary event of interest;
determining a total possible audience for a gathering directed toward the primary event of interest in each of the plurality of geographic regions;
generating at least one regional event weighting factor for each region of the plurality of geographic regions, each regional event weighting factor associated with at least one geographic region having access to the primary event of interest;
generating a global event weighting factor, the global event weighting factor associated with the primary event of interest; and
predicting a plurality of expected attendance estimates, each of the plurality of expected attendance estimates being an expected attendance estimate for the gathering at a venue located within a respective geographic region, wherein each predicted expected attendance estimate is generated by mathematically combining an associated regional event weighting factor and the global event weighting factor with the associated total possible audience.

12. The non-transitory computer-readable storage medium according to claim 11 whose stored contents configure the computing system to perform the method, the method further comprising:
based on at least one of the plurality of expected attendance estimates, electronically communicating the at least one of the plurality of expected attendance estimates to the venue located within the respective geographic region.

13. The non-transitory computer-readable storage medium according to claim 11 whose stored contents configure the computing system to perform the method, wherein generating at least one regional event weighting factor includes applying historical data from previous primary events of interest.

14. The non-transitory computer-readable storage medium according to claim 11 whose stored contents configure the computing system to perform the method, wherein generating each regional event weighting factor includes applying first data and second data, wherein the first data represents an increase in popularity of the primary event of interest and wherein the second data represents a decrease in popularity of the primary event of interest.

15. The non-transitory computer-readable storage medium according to claim 14 whose stored contents configure the computing system to perform the method, wherein application of the first data is performed in a first processing system and wherein application of the second data is performed in a second processing system, the first processing system different from the second processing system.

16. An event-to-spectator correlation tool, comprising:
a multiprocessor computing system, the multiprocessor computing system having a first processor and a second processor;
at least one memory coupled to the multiprocessor computing system, the at least one memory arranged to store computer instructions executable by the first and second processors of the multiprocessor computing system, wherein the computer instructions are arranged to direct the multiprocessor computing system to:
identify a gathering to view an event at a venue;
determine a total possible attendance at the gathering;
determine a regional popularity of the event;
determine a global popularity of the event; and
predict an expected attendance at the venue by cooperatively attenuating the total possible attendance based on a combination of the regional popularity of the event and the global popularity of the event.

17. An event-to-spectator correlation tool according to claim 16, comprising:
a wide area network (WAN) communications port, wherein the computer instructions are arranged to direct the multiprocessor computing system to:
communicate information about the event to a plurality of mobile devices.

18. An event-to-spectator correlation tool according to claim 16 wherein the first processor determines at least one first factor that represents an increase in popularity of the event and wherein the second processor determines at least one second factor that represents a decrease in popularity of the event.

19. An event-to-spectator correlation tool according to claim 18 wherein determination of the at least one first factor by the first processor and determination of the at least one second factor by the second processor occur in parallel.

20. An event-to-spectator correlation tool according to claim 16 wherein the computer instructions are further arranged to direct the multiprocessor computing system to:
multiply a first value, a second value, and a third value to produce a product, wherein the first value represents the total possible attendance, wherein the second value represents the regional popularity of the event, wherein the third value represents the global popularity of the event, and wherein the product represents the predicted expected attendance at the venue.
